(19) United States
(12) Patent Application Publication
(10) Pub. No.: US 2025/0342101 A1
(43) Pub. Date: Nov. 6, 2025

(54) APPARATUS AND METHOD FOR PROVIDING EXPERIMENT RESULT AND EXPERIMENT HISTORY OF ARTIFICIAL INTELLIGENCE BASED MODEL

(71) Applicant: NOTA, INC., Daejeon (KR)

(72) Inventor: Youngeun KIM, Daejeon (KR)

(21) Appl. No.: 18/915,039

(22) Filed: Oct. 14, 2024

(30) Foreign Application Priority Data
May 3, 2024 (KR) 10-2024-0059080
Jun. 20, 2024 (KR) 10-2024-0080518

(51) Int. Cl. G06F 11/34; G06F 8/35; G06F 8/38

(52) U.S. Cl. CPC G06F 11/3447; G06F 8/35; G06F 8/38

(57) ABSTRACT

In accordance with an embodiment of the present disclosure, a method performed by a computing device is disclosed. The method includes presenting a user interface for a development project of an artificial intelligence model The method includes in response to receiving an object selection input to select a first lower object connected dependently to a first upper object in the hierarchical structure of the first area. The method includes displaying a first experiment of a first model corresponding to the first lower object in the second area. The method includes in response to receiving an experiment input to perform a second experiment of the first model in the second area, displaying information related to the second experiment in the second area and updating the hierarchical structure in the first area based on the second experiment.

### CROSS-REFERENCE TO RELATED APPLICATIONS

This application claims priority to and the benefit of Korean Patent Application No. 10-2024-0080518 filed in the Korean Intellectual Property Office on Jun. 20, 2024 and Korean Patent Application No. 10-2024-0059080 filed in the Korean Intellectual Property Office on May 3, 2024, the entire contents of which are incorporated herein by reference.

### BACKGROUND

### Technical Field

This disclosure relates to artificial intelligence technology, and more specifically, to a method and apparatus for providing experiment result and experiment history of artificial intelligence based model.

### Description of the Related Art

Artificial intelligence related technologies that realize human intelligence are used in various industries. A demand for edge technology or artificial intelligence technology, which can lead to a direct operation in terminals on networks such as personal computers, smartphones, cars, wearable devices and robots, increases.

With the development of the edge technology and as the importance of hardware in the artificial intelligence technology field increases, a knowledge for optimization of the model and sufficient knowledge of various hardware in which the artificial intelligence based models are to be executed in addition to a knowledge of the model itself is also required.

In the development of the AI model, numerous experiments may be conducted, and various hyperparameters, datasets, algorithms and performance indicators may be considered during each experiment. Systematically managing data related to these artificial intelligence models can be a very important factor in the development of the artificial intelligence model. The more experiments are, the more difficult to track the results and settings of the experiment, which can lead to waste of time and resources.

US Patent Application Laid-Open No. 2002-0121927 discloses providing a group of neural networks for processing data.

### BRIEF SUMMARY

The present disclosure has been made in an effort to efficiently provide training and an optimization experiment result of an artificial intelligence model.

The present disclosure has been made in an effort to efficiently provide and update an experiment history of the artificial intelligence model.

The present disclosure has been made in an effort to increase a user experience through a user interface (UI) related to the artificial intelligence model.

Technical objects of the present disclosure are not restricted to the technical object mentioned above. Other unmentioned technical objects will be apparently appreciated by those skilled in the art by referencing the following description.

In accordance with an embodiment of the present disclosure, a method performed by a computing device is disclosed. The method comprises: presenting a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display predetermined experiment categories and a lower layer with at least one lower object that identifies an experiment pipeline of the model within each of the experiment categories, each of the experiment categories corresponds to one upper object, and the lower object is connected dependently to the upper object, in response to receiving an object selection input to select a first lower object connected dependently to a first upper object in the hierarchical structure of the first area, displaying a first experiment of a first model corresponding to the first lower object in the second area, and in response to receiving an experiment input to perform a second experiment of the first model in the second area, displaying information related to the second experiment in the second area and updating the hierarchical structure in the first area based on the second experiment.

In accordance with an embodiment of the present disclosure, the experiment categories comprises a first experiment category indicating that training of the model has been performed, a second experiment category indicating that compression of the model has been performed, and a third experiment category indicating that the model is a pre-trained model. When compression is performed on a trained model or a pre-trained model during an experiment process of the model, a lower object representing an experiment pipeline for the compressed model is added under an upper object representing the second experiment category.

In accordance with an embodiment of the present disclosure, the experiment pipeline identifies experiments applied to the model from among a group of experiments including training, retraining, compression, converting, and benchmarking.

In accordance with an embodiment of the present disclosure, the updating the hierarchical structure comprises: displaying, on the hierarchical structure, a second lower object representing an experiment pipeline that includes the first experiment and the second experiment of the first model, by adding a second experiment indicator corresponding to the second experiment to a first experiment indicator corresponding to the first experiment of the first model.

In accordance with an embodiment of the present disclosure, the updating the hierarchical structure comprises: determining an upper object to which a second lower object corresponding to the second experiment is connected dependently, based on an experiment category of the first upper object to which the first lower object is dependently connected and a type of the second experiment.

In accordance with an embodiment of the present disclosure, a lower object on the hierarchical structure in the first area displays identification information of a trained model, compression information indicating a compression method of the model, a converting indicator indicating whether a model is converted, a benchmark indicator indicating whether a model is benchmarked, and a retraining indicator indicating whether a model is retrained.

In accordance with an embodiment of the present disclosure, the second area displays results of experiments with the same experiment category among multiple different experiments performed on the same trained model in a comparable format based on the performance of the trained model.

In accordance with an embodiment of the present disclosure, the displaying the first experiment of the first model corresponding to the first lower object in the second area comprises: displaying, in the second area, storage location of a file corresponding to the first model, identification information of the first model, task information of the first model, type of the first experiment, a target device of the first experiment, and current experiment status of the first experiment.

In accordance with an embodiment of the present disclosure, the displaying the first experiment of the first model corresponding to the first lower object in the second area comprises: displaying, in the second area, information related to a third experiment corresponding to a third lower object connected dependently to the first upper object in the hierarchical structure in the first area, in a comparable format with information related to the first experiment. The third experiment is an experiment on the first model and is performed before the second experiment, and display positions of information related to the third experiment and information related to the first experiment in the second area are determined based on occurrence times of the third experiment and the first experiment.

In accordance with an embodiment of the present disclosure, the method further comprises: after the displaying, in the second area, information related to the third experiment in a comparable format with and information related to the first experiment, displaying an input window to receive an additional experiment input corresponding to a fourth experiment on the first model to which the first experiment is not applied and the third experiment is applied, in response to a user selection input selecting information related to the third experiment in the second area, and in response to the additional experiment input, displaying information related to the fourth experiment in the second area and updating the hierarchical structure in the first area based on the fourth experiment.

In accordance with an embodiment of the present disclosure, the displaying, in the second area, information related to the third experiment in a comparable format with and information related to the first experiment comprises: displaying, in the second area, information related to a fifth experiment corresponding to a fifth lower object connected dependently to a second upper object different from the first upper object in the hierarchical structure of the first area, together with information related to the third experiment and information related to the first experiment, in a comparable format. The method further comprise: providing an access to the fifth lower object and displaying, in the second area, storage location of a file corresponding to the first model, identification information of the first model, task information of the first model, and current experiment status of the fifth experiment, in response to a user selection input selecting information related to the fifth experiment in the second area. The fifth experiment is an experiment for training the first model and is performed before the first experiment and the third experiment, and the first experiment and the third experiment are experiments for compressing the trained first model.

In accordance with an embodiment of the present disclosure, the method further comprises: after the displaying the first experiment of the first model corresponding to the first lower object in the second area, receiving a user selection input selecting a download object displayed in the second area, and generating download files corresponding to multiple experiments included in a first experiment pipeline corresponding to the first lower object. The first experiment pipeline corresponding to the first lower object includes the first experiment of the first model and another experiment of the first model performed before the first experiment, and the download files are generated such that one download file is created for each experiment among the multiple experiments.

In accordance with an embodiment of the present disclosure, the generating the download files corresponding to the multiple experiments included in the first experiment pipeline corresponding to the first lower object comprises: generating a first download file corresponding to the first model before application of the converting experiment and a second download file corresponding to the first model after the application of the converting experiment, when the converting experiment is included in the first experiment pipeline. A name of the first download file includes a quantization unit of a first type, and a name of the second download file includes a quantization unit of a second type.

In accordance with an embodiment of the present disclosure, the method further comprises: after the displaying the first experiment of the first model corresponding to the first lower object in the second area, receiving a user selection input selecting a visualization object displayed in the second area, and generating performance images corresponding to multiple experiments included in the first experiment pipeline corresponding to the first lower object. Each of the performance images visually displays, in a comparable format, a first performance of the first model in which a training experiment is applied within the first experiment pipeline and a second performance of the first model to which a subsequent experiment is applied after the training experiment within the first experiment pipeline.

In accordance with an embodiment of the present disclosure, the method further comprises: displaying an input area in a second user interface for the development project to allow for a second user interaction for an experiment of the model, and in response to receiving user code input for a customized experiment of the first model in the input area, updating the hierarchical structure in the first area of the first user interface based on the customized experiment of the first model corresponding to the user code input. The second user interface and the first user interface are different user interfaces that allow different types of input and are interworked for the development project.

In accordance with an embodiment of the present disclosure, the second area of the first user interface displays code information generated to perform the first experiment of the first model in response to a user code generation input. The code information is compatible with the user code input for the customized experiment in the second user interface.

In accordance with an embodiment of the present disclosure, when the experiment of the model includes training or retraining of the model, the training or retraining of the model is performed using computing resources of the computing device. When the experiment of the model includes compression, converting, or benchmarking of the model, an experiment request related to the experiment of the model is transmitted to a second computing device external to the computing device, the compression, converting, or benchmarking of the model is performed using computing resources of the second computing device, and an experiment result corresponding to the experiment request of the model is transmitted from the second computing device to the computing device.

In accordance with an embodiment of the present disclosure, a non-transitory computer-readable medium comprising a computer program is disclosed. When the computer program is executed by a computing device, the computer program allows the computing device to perform a method. The method comprises: presenting a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display predetermined experiment categories and a lower layer with at least one lower object that identifies an experiment pipeline of the model within each of the experiment categories, each of the experiment categories corresponds to one upper object, and the lower object is connected dependently to the upper object, in response to receiving an object selection input to select a first lower object connected dependently to a first upper object in the hierarchical structure of the first area, displaying a first experiment of a first model corresponding to the first lower object in the second area, and in response to receiving an experiment input to perform a second experiment of the first model in the second area, displaying information related to the second experiment in the second area and updating the hierarchical structure in the first area based on the second experiment.

In accordance with an embodiment of the present disclosure, a computing device comprising at least one processor, a memory and a display is disclosed. The at least one processor is configured to: present a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display predetermined experiment categories and a lower layer with at least one lower object that identifies an experiment pipeline of the model within each of the experiment categories, each of the experiment categories corresponds to one upper object, and the lower object is connected dependently to the upper object, in response to receiving an object selection input to select a first lower object connected dependently to a first upper object in the hierarchical structure of the first area, display a first experiment of a first model corresponding to the first lower object in the second area, and in response to receiving an experiment input to perform a second experiment of the first model in the second area, display information related to the second experiment in the second area and update the hierarchical structure in the first area based on the second experiment.

According to a technique according to an embodiment of the present disclosure, an experiment result of an artificial intelligence model can be efficiently provided.

According to a technique according to an embodiment of the present disclosure, an experiment history of the artificial intelligence model can be efficiently provided and updated.

According to a technique according to an embodiment of the present disclosure, a user experience can be increased through a user interface (UI) related to the artificial intelligence model.

### BRIEF DESCRIPTION OF THE SEVERAL VIEWS OF THE DRAWINGS

FIG. 1 schematically illustrates a block diagram of a computing device according to an embodiment of the present disclosure.

FIG. 2 schematically illustrates a configuration diagram of a system according to an embodiment of the present disclosure.

FIG. 3 illustrates an exemplary structure of an artificial intelligence-based? model according to an embodiment of the present disclosure.

FIG. 4 exemplarily illustrates a method for providing an experiment history and an experiment result of the artificial intelligence model according to an embodiment of the present disclosure.

FIG. 5 exemplarily illustrates a user interface including the experiment history and the experiment result of the artificial intelligence model according to an embodiment of the present disclosure.

FIG. 6 exemplarily illustrates a hierarchical structure of experiment histories according to an embodiment of the present disclosure.

FIG. 7 exemplarily illustrates an experiment result according to an embodiment of the present disclosure.

FIG. 8 exemplarily illustrates an experiment result according to an embodiment of the present disclosure.

FIGS. 9, 10, and 11 exemplarily illustrate an experiment result to which a visualization element is applied according to an embodiment of the present disclosure.

FIG. 12 exemplarily illustrates a user interface of a training experiment according to an embodiment of the present disclosure.

FIG. 13 exemplarily illustrates a user interface of a compression experiment according to an embodiment of the present disclosure.

FIG. 14 exemplarily illustrates a user interface of a converting experiment according to an embodiment of the present disclosure.

FIG. 15 exemplarily illustrates a user interface of a benchmark experiment according to an embodiment of the present disclosure.

FIG. 16 exemplarily illustrates a user interface for downloading an experiment result according to an embodiment of the present disclosure.

FIG. 17 exemplarily illustrates a second user interface of the present disclosure.

FIG. 18 illustrates an exemplary folder structure according to an embodiment of the present disclosure.

FIG. 19 is a schematic diagram of a computing environment according to an embodiment of the present disclosure.

### DETAILED DESCRIPTION

Various embodiments will be described with reference to drawings. In the specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module”, “system”, and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A”, “a case including only B”, and “a case in which A and B are combined”.

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

Those skilled in the art should additionally recognize that the various exemplary logical components described in connection with the embodiments disclosed herein can be implemented in hardware, computer software, or a combination of both.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

“Artificial intelligence model” in the present disclosure may be used as a meaning that encompasses the model, the artificial intelligence based model, the computation model, the neural network, a network function, and the neural network.

In an embodiment, the model may mean a model file, identification information of the model, an execution configuration of the model, and a framework of the model. For example, TensorRT, Tflite, and/or Onnxruntime may correspond to the model.

A term “development project” used in the present disclosure may mean any type of experiment or set of experiments for developing, producing, or testing the artificial intelligence model. For example, the development project may represent a series of processes of producing an artificial intelligence model desired by a user by applying one or more experiments to the artificial intelligence model.

The term “experiment” used in the present disclosure may mean various processes and methodologies applied to the artificial intelligence model under the development project. As a non-limited example, such an experiment may include training of a model, compression of the model, converting of the model, and/or a benchmark of the model. A set or an application order of such a series of experiments may be expressed as “experiment pipeline”. For example, when a training experiment and a compression experiment are made, the experiment pipeline of corresponding model may be identified by training-compression. As another example, when the training experiment, the compression experiment, and the converting experiment are sequentially made, the experiment pipeline of the corresponding model may be identified by ‘training-compression-converting’. “Experiment history” in the present disclosure may mean a result of intuitively and systematically recording results of a plurality of respective experiments for a plurality of models.

The term “benchmark” used in the present disclosure may mean an operation of executing or testing the model in hardware or an operation of measuring the performance for the hardware of the model. Performance information may be acquired which is acquired as a result model of the benchmark is executed in the hardware. Performance information may be acquired when the result model of the benchmark is executed in the hardware. The hardware may be used as a meaning that encompasses physical hardware, virtual hardware, hardware which is impossible to be accessed through the network from the outside, hardware which is impossible to confirm externally, and/or hardware which is confirmed in a cloud. For example, the hardware in the present disclosure may include various types of hardware such as Jetson Nano, Jetson Xavier NX, Jetson TX2, Jetson AGX Xavier, Jetson AGX Orin, GPU AWS-T4, Xeon-W-2223, Raspberry Pi Zero, Raspberry Pi 2W, Raspberry Pi 3B+, Raspberry Pi Zero 4B, and Mobile.

A layer in the present disclosure may be used to mean a component constituting the model. For example, one model may include a plurality of layers. For example, the plurality of layers may be connected to each other through an edge. An operation of the model may be performed through a computation performed in the plurality of layers. For example, the layer may be interchangeably used with an operator of the model. As an example, a convolutional layer included in a model that performs object recognition in an image by receiving the image may become an example for the layer in the model.

A training model and an original model in the present disclosure may be used exchangeable with each other.

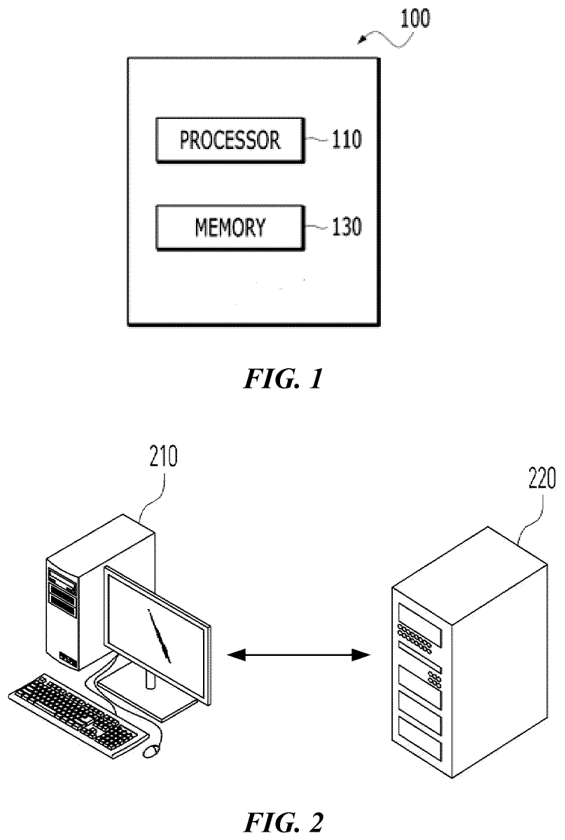

FIG. 1 schematically illustrates a block diagram of a computing device 100 according to an embodiment of the present disclosure.

The computing device 100 according to an embodiment of the present disclosure may include a processor 110 and a memory 130.

A configuration of the computing device 100 illustrated in FIG. 1 is only an example simplified and illustrated. In an embodiment of the present disclosure, the computing device 100 may include other components for performing a computing environment of the computing device 100, and only some of the disclosed components may constitute the computing device 100.

The computing device 100 in this disclosure may be used to encompass any form of server and/or any type of terminal.

The computing device 100 in the present disclosure may mean an any type of component constituting a system for implementing the embodiments of the present disclosure.

The components of the computing device 100 shown in FIG. 1 are exemplary, and some may be omitted, or additional components may be included in the computing device 100. As an example, when the computing device 100 includes the user terminal, an output unit (not illustrated) and an input unit (not illustrated) may be included in a range of the computing device 100.

In an embodiment, the computing device 100 may mean a device that manages and/or performs a development project of a specified artificial intelligence model in communication with one or more devices. For example, the computing device 100 may generate or provide a user interface for allowing one or more devices to manage and/or perform the development project of the specified artificial intelligence based model by communicating with one or more devices. For example, the computing device 100 may output the user interface for allowing the development project of the artificial intelligence based model to be managed and/or performed, and output, through the user interface, information acquired by performing communication with one or more devices in response to a user input on the user interface.

In an embodiment, the computing device 100 may interact with an input from a user. For example, the computing device 100 may generate or acquire an experiment result corresponding to an input requested from the user. For example, the computing device 100 may update a hierarchical structure output on the user interface based on the experiment result generated in response to the input acquired from the user.

In an embodiment, the computing device 100 may generate or acquire the training model, generate the compressed model, generate the converted model, generate the benchmark result, and/or generate the download data for deploying. In an embodiment, the computing device 100 may generate or acquire the training model, generate the compressed model, generate the converted model, generate the benchmark result, and/or generate the download data for deploying.

In an embodiment, the computing device 100 may acquire input data including a dataset, and generate or acquire a training model corresponding to a user input in response to an input related to training, such as an inference task, etc. According to an implementation aspect, generation of the training model may be performed by another computing device or external entity, and a corresponding content may also be reflected to the computing device 100.

In an embodiment, the computing device 100 may acquire a compression result (e.g., a lightweight model) of the training model from another entity. In an embodiment, the computing device 100 may also generate the lightweighting model by compressing the training model. The computing device 100 may also receive compression setting data for the training model, and compress the training model based on the input.

In an embodiment, the computing device 100 may acquire a converting result (e.g., a converting model) for the training model or the compression model from another entity. In an embodiment, the computing device 100 may also perform converting for the training model or the compression model. As converting is performed, the converting model corresponding to the training model or the compression model may be generated.

In an embodiment, the computing device 100 may acquire a benchmark result corresponding to the training model, the compression model, and/or the converting model.

In an embodiment, the processor 110 may be constituted by at least one core and may include processors for data analysis and/or processing, such as a central processing unit (CPU), a general purpose graphics processing unit (GPGPU), a graphics processing unit (GPU), a neural processing unit (NPU), and a tensor processing unit (TPU) of the computing device 100.

The processor 110 may read a computer program stored in the memory 130 to provide the benchmark result according to an embodiment of the present disclosure.

According to an embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function. Further, in an embodiment of the present disclosure, learning of the network function and data classification using the network function may also be processed by using processors of a plurality of computing devices. In addition, the computer program performed by the computing device 100 according to an embodiment of the present disclosure may be a CPU, GPGPU, or TPU executable program.

Additionally, the processor 110 may generally process all operations of the computer device 100. For example, the processor 110 processes data, information, or a signal input or output through the components included in the computing device 100 or drives an application program stored in a storage unit to provide an appropriate information or function to a user.

According to an embodiment of the present disclosure, the memory 130 may store various types of information generated or determined by the processor 110 or various types of information received by the computing device 100. According to an embodiment of the present disclosure, the memory 130 may be a storage medium storing computer software which performs the operations according to the embodiments of the present disclosure by the processor 110. Therefore, the memory 130 may also mean computer reading media for storing a software code required for performing the embodiment of the present disclosure, data which becomes an execution target of the code, and an execution result of the code.

The memory 130 according to an embodiment of the present disclosure may mean an arbitrary type of storage medium. For example, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may also operate in connection with a web storage performing a storing function of the memory 130 on the Internet. The disclosure of the memory is just an example, and the memory 130 used in the present disclosure is not limited to the examples.

A communication unit (not illustrated) in the present disclosure may be configured regardless of communication modes such as wired and wireless modes and constituted by various communication networks including a personal area network (PAN), a wide area network (WAN), and the like. Further, the network unit 150 may be the known World Wide Web (WWW) and may adopt a wireless transmission technology used for short-distance communication, such as infrared data association (IrDA) or Bluetooth.

The computing device 100 in the present disclosure may include various types of user terminal and/or various types of server. Therefore, the embodiments of the present disclosure may be performed by the server and/or the user terminal.

In an embodiment, the user terminal may include an arbitrary type of terminal which is capable of interacting with the server or another computing device. The user terminal may include, for example, a cellular phone, a smart phone, a laptop computer, a personal digital assistant (PDA), a slate PC, a tablet PC, and an ultrabook.

In an embodiment, the server may include, for example, various types of computing system or computing device such as a microprocessor, a mainframe computer, a digital processor, a portable device, and a device controller.

For example, the computing device 100 may include a storage unit (not shown) for storing the aforementioned information. This storage unit may be integrated within the computing device 100 or exist under the management of the computing device 100. In another example, the storage unit may reside outside the computing device 100 and be implemented in a manner that allows communication with it. In this case, the storage unit may be managed and controlled by an external device different from the computing device 100.

FIG. 2 schematically illustrates a configuration diagram of a system according to an embodiment of the present disclosure.

According to the embodiment of the present disclosure, the system may include a first computing device 210 and a second computing device 220.

The first computing device 210 may correspond to a user terminal. The first computing device 210 may receive an input from the user and output an output corresponding to the input.

The second computing device 200 may generate a user interface and/or generate an experiment result based on a user input which is input through the user interface. The second computing device 200 may correspond to a server.

The second computing device 200 may provide the user interface according to an embodiment of the present disclosure to the first computing device 210. The first computing device 210 may receive the input from the user and output information on the user interface. Based on the user input received through the user interface in the first computing device 210, the second computing device 220 may perform an experiment (e.g., a compression experiment, a converting experiment, and/or a benchmark experiment) for a model. The first computing device 210 may output the result of the experiment through the user interface.

Based on the user input received through the user interface in the first computing device 210, an experiment (e.g., a training experiment, a re-training experiment, etc.) for the model in the first computing device 210 may be performed. In this case, the experiment result corresponding to the experiment of the model may be delivered to the second computing device 220, and the second computing device 220 may update a hierarchical structure on the user interface based on the experiment result.

In an embodiment, the first computing device 210 and the second computing device 220 may include a hardware resource for performing the experiment of the model. In an embodiment, based on a category of the experiment or identification information of the experiment of the model, a computing device which is to perform the experiment of the model may be determined between the second computing device 220 and the first computing device 210. For example, when the category of the experiment of the model is training, a computing resource of the first computing device 210 corresponding to a client terminal may be used to perform the experiment of the model. Accordingly, the experiment related to the training may be performed by the first computing device 210, and the result of the experiment may also be output through the first computing device 210. In such an example, the first computing device 210 may update the hierarchical structure on the user interface based on the result of the experiment. In another example, the result of the experiment is delivered to the second computing device 220, so the second computing device 220 may update the hierarchical structure on the user interface. As another example, when the category of the experiment of the model is compression, converting, and/or benchmark, the computing resource of the second computing device 220 corresponding to the server may be used to perform the experiment of the model. Accordingly, the experiments related to the compression, the converting, and/or the benchmark may be performed by the second computing device 220, and the result of the experiment may be output through the first computing device 210.

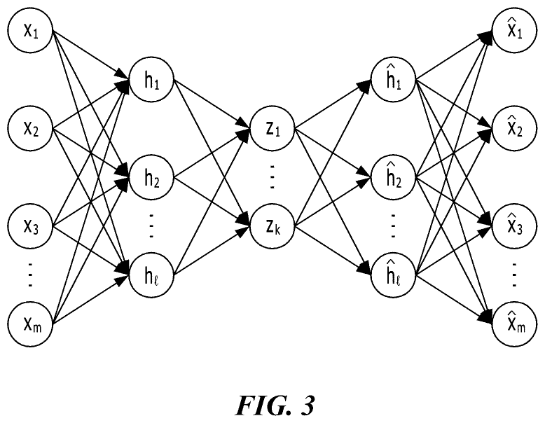

FIG. 3 illustrates an illustrative structure of an artificial intelligence based model according to an embodiment of the present disclosure.

Throughout the present disclosure, the model, the artificial intelligence model, the artificial intelligence based model, the operation model, and the neural network, the network function, and the neural network may be used interchangeably.

The artificial intelligence based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links.

The nodes representing the units that constitute a neural network can be distinguished from the nodes representing the hardware on which the model is executed. For example, within an AI-based model, a node may refer to a component that makes up the neural network, and, for instance, a node in the neural network can correspond to a neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another embodiment of the present disclosure, the number of nodes of the input layer may be larger than the number of nodes of the output layer, and the neural network may be a neural network of a type in which the number of nodes decreases from the input layer to the hidden layer. The neural network according to still yet another embodiment of the present disclosure may be a neural network of a type in which the neural networks are combined.

A deep neural network (DNN) refers to a neural network that includes multiple hidden layers in addition to input and output layers. Using a DNN allows for the identification of latent structures within data. For example, it can uncover latent structures in images, text, videos, speech, protein sequence structures, gene sequence structures, peptide sequences, and/or music (e.g., identifying objects in an image, understanding the content and sentiment of text, or recognizing the content and emotion in speech). A DNN may include various architectures such as convolutional neural networks (CNNs), recurrent neural networks (RNNs), autoencoders, generative adversarial networks (GANs), restricted Boltzmann machines (RBMs), deep belief networks (DBNs), Q-networks, U-networks, Siamese networks, GANs (Generative Adversarial Networks), Transformers, and diffusion models. The mention of these DNN architectures is merely exemplary, and the present disclosure is not limited thereto.

The artificial intelligence based model of the present disclosure may be expressed by a network structure of an arbitrary structure described above, including the input layer, the hidden layer, and the output layer. For example, the input layer, hidden layers, and output layer of such AI-based models can each correspond to nodes. In this example, a combination of these nodes can correspond to a block.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

A computer-readable medium storing a user interface, experimental results, and/or data structures including AI-based models, in accordance with an embodiment of the present disclosure, is provided. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

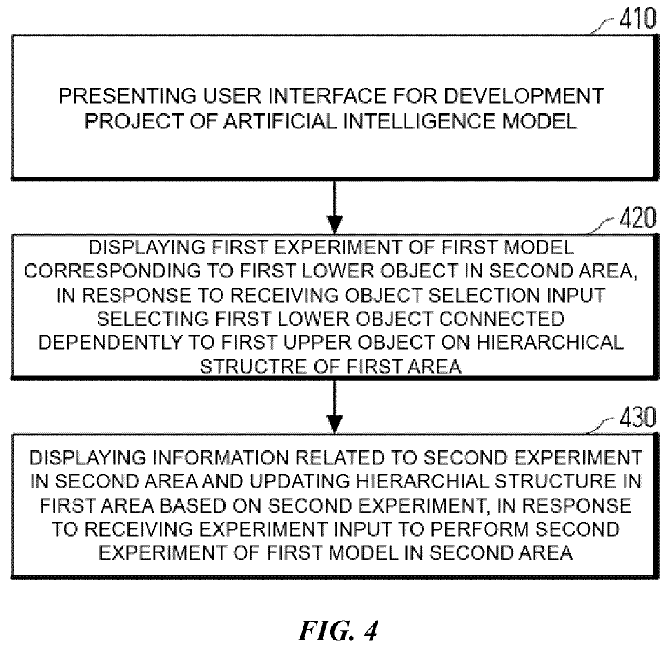

FIG. 4 exemplarily illustrates a method for providing an experiment history and an experiment result of the artificial intelligence model according to an embodiment of the present disclosure.

In an embodiment, the method illustrated in FIG. 4 may be performed by the computing device 100. As an example, the method illustrated in FIG. 4 may be performed by the first computing device 210 which interacts with the user through the user interface. As another example, the method illustrated in FIG. 4 may be performed by the computing device 100 that encompasses the first computing device 210 and the second computing device 220.

Hereinbelow, an example in which steps of FIG. 4 are performed by the computing device 100 will be described in detail. It will be appreciated by those skilled in the art that some of the steps illustrated in FIG. 4 may be omitted or an additional step may be included according to the implementation aspect.

The experiment history in the present disclosure may mean a list of experiment identification information applied according to time. The experiment history in the present disclosure may mean an experiment pipeline representing applied experiments.

In an embodiment, the computing device 100 may display the user interface for the development project of the artificial intelligence based model (410).

In an embodiment, the computing device 100 may receive a user input which intends to develop a specific model. For example, the user input may include a model file (i.e., a pretrained model) of which modeling is made. For example, the user input may include a dataset for modeling.

In an embodiment, the user interface may express the experiment history of the model. The user interface may allow a user interaction for the experiment of the model. The user interface may receive and output any type of information for performing the development project of the model. The user interface may identify the experiment history (e.g., the experiment pipeline) of the model in the form of the hierarchical structure. As an example, an optimization model file according to the experiment pipeline may be stored in the form of a folder structure. As an example, the folder structure storing the optimization model file according to the experiment pipeline may have the form of the hierarchical structure. As an example, the experiment pipeline may be identified through a name of the optimization model file.

In an embodiment, the user interface may be generated by another device outside the computing device 100, and the user interface may be delivered to the computing device 100 such as the user terminal to allow the user interaction.

In an embodiment, there may be a plurality of user interfaces which allow the user interaction. The plurality of respective user interfaces may be used for user interactions of different forms. The plurality of respective user interfaces may allow the user interactions of different forms. The plurality of respective user interfaces may allow inputs having degrees of freedom having different levels. A first user interface may be configured to allow selection of an object and input in a predetermined item. A second user interface may be configured to allow a code type user input. An input freedom degree of the second user interface may be higher than an input freedom degree of the first user interface. The high freedom degree may represent that a possibility of customizing of an input is high. An experiment result on the first user interface and an experiment result on the second user interface may interlock with each other. For example, the an experiment result according to an input on the first user interface may be confirmed on the second user interface, and an experiment result according to an input on the second user interface may be confirmed on the first user interface.

In an embodiment, the user interface may receive a user input for generating the development project. The user input for generating the development project may include log-in information, identification information of a project, and/or storage information of the project.

In an embodiment, the user interface may acquire a user input (e.g., a user input for generating the training model) for training the model. As an example, the user input may include a dataset which becomes a target of the training. As an example, the user input may include information for identifying a task of the training model. As an example, the user input may include information for identifying a neural network type or a model type of the training model. As an example, the user input may include a training scheme (e.g., an input shape and a training configuration). The computing device 100 may generate or acquire the training model in response to the user input. The training model may be stored in a storage space corresponding to storage information of the development project.

In an embodiment, the user interface may express the pretrained model. Here, the pretrained model may correspond to a model which is trained outside the user interface. The computing device 100 receives a model file corresponding to the pretrained model to acquire the pretrained model.

As described above, both the model which is trained through the user interface and the pretrained model may be included in the category of the training model in the present disclosure.

In an embodiment, the experiments such as the compression, the converting, and the benchmark may be made with the training model as a start point. An experiment pipeline having the training experiment as a start experiment may be generated. For example, a first experiment pipeline may include a training experiment, a compression experiment, and a converting experiment of a first model. For example, a second experiment pipeline may include the training experiment and the compression experiment of the first model. For example, a third experiment pipeline may include a training experiment and a compression experiment of a second model. For example, a fourth experiment pipeline may include the training experiment, a converting experiment, and a benchmark experiment of the second model.

The experiment pipeline may identify a series of experiments applied to the model. As an example, when only one training experiment may constitute the experiment pipeline or as another example, when the re-training experiment is made after the training experiment, an experiment pipeline of ‘training-re-training’ may be constituted.

In an embodiment, the user interface may include a first area representing the experiment history of the model in the form of the hierarchical structure and a second area allowing the user interaction for the experiment of the model.

The hierarchical structure represented in the first area may include an upper layer including upper objects and a lower layer including lower objects. The hierarchical structure may include an upper layer including upper objects distinguishably representing predetermined experiment categories.

One experiment category may correspond to one upper object on the upper layer. For example, an upper object for representing a model to which the training experiment is applied on the user interface, an upper object for representing a model to which the compression experiment is applied, and an upper object for representing the pretrained model may be included in the upper layer. As exemplified in a detailed description of the user interface below, the experiment category may be divided into a trainer model representing that the training of the model is performed, a compressed model representing that the compression of the model is performed, and a pretrained model representing that the model is the pretrained model. The experiment pipeline may identify the experiments applied to the model among groups of the experiments including training, re-training, compression, converting, and benchmark. When the training model as a start point is different or when types or orders of experiments applied to the training model are different, it may be considered that the experiment pipelines are different. When the experiment pipelines are different, the experiment pipelines may be represented as different lower objects on the lower layer. When a representation scheme of the lower object according to an embodiment of the present disclosure is used, the experiment pipeline of the lower object may be intuitively confirmed through identification information of the lower object. When identification information of the upper object to which the lower object according to an embodiment of the present disclosure is connected, and a representation scheme of the lower object are used, the experiment pipeline of the lower object may be intuitively confirmed.

Each of the lower objects on the lower layer may be used to represent the experiment pipeline of the model. For example, the lower object may be determined or generated based on the identification information of the model, the category of the experiment applied to the model, and the order of the experiments applied to the model. The lower object may be connected dependently to the upper object. A plurality of lower objects may be connected dependently to one upper object. The upper object may be considered as an upper folder, and the lower object may be considered as a lower folder in the upper folder. The representation of dependent connection may mean, for example that there the lower object exists as a lower concept of the corresponding upper object in a situation in which the upper object and the lower object exist. When the upper object is selected, one or more lower objects may be represented.

Since the first area may represent the experiment pipeline on a hierarchical structure constituted by the upper object and the lower object, the experiment history of the model may be intuitively confirmed through the hierarchical structure on the first area.

The second area may receive a user input for performing the experiment for the model, and output the experiment result for the model. When a specific lower object on the first area is selected, experiment information corresponding to the selected lower object may be displayed on the second area. When an additional experiment input on the second area is received, an experiment result corresponding to an additional experiment may be displayed on the second area, and the hierarchical structure on the first area may be updated based on the experiment result. For example, when compression of a model which is trained during an experiment process of a specific model or a pretrained model is performed, a lower object representing the experiment pipeline for the compressed model may be generated in and/or added to an upper object representing a second experiment category.

In an embodiment, when the computing device 100 receives an object selection input to select a first lower object connected to dependently to a first upper object on the hierarchical structure of the first area, a first experiment of a first model corresponding to the first lower object may be displayed in the second area (420).

In an embodiment, a plurality of upper objects and lower objects dependent on the upper objects, respectively may be formed on the hierarchical structure of the first area. When a user input to select a specific lower object is acquired on the user interface, the computing device 100 may display experiment information corresponding to the selected lower object in the second area of the user interface. For example, it is assumed that the first upper object is a compression category, and the first lower object represents that the compression experiment is performed in the training model. Under the assumption, when the first lower object is selected, experiment information for representing an experiment pipeline (i.e., training-compression) corresponding to the first lower object may be displayed in the second area.

For example, the information displayed in the second area may include a category (e.g., type) of an experiment, a type of training model, a task of the training model, a storage location of the model, a result of the experiment, a performance comparison of the experiment, an input object for performing an additional experiment, and/or a code for performing the experiment.

For example, the information displayed in the second area may include a storage location of a file corresponding to the model, identification information of the model, task information of the model, a type of experiment, a target device of the experiment, and a current experiment state of the experiment. The task information of the model may include information related to a function of the model, such as classification or detection. The task information of the model may include information for identifying an object which becomes a target of the classification or detection. The current experiment state may include a completion state, an in-progress state, a stop state, etc.

In an embodiment, the second area may display results of experiments having the same experiment category among results of a plurality of different experiments performed with the same training model as a target in a comparable format based on a performance of the training model. For example, when there are results (e.g., compressed models of various schemes) of experiment pipelines for different original models (training models), the computing device 100 may display the results performed for the same original model to be comparable. The display of the comparable format may have a form of comparing each of the compressed models of various schemes and the performance of the original model. The display of the comparable format may have a form of comparing the performances of the respective compressed models of various schemes. As another example, the computing device 100 may display results of respective experiment pipelines to be comparable based on the same original model and the same target device when visualizing the benchmark result. As an example, the display of the comparable format may include comparing an original model and models to which the experiment is applied in a form of a graph or a table based on the same factor. As an example, the display of the comparable format may include comparing respective models to which the experiment is applied in the form of the graph or table based on the same factor.

In an embodiment, the computing device 100 may display, in the second area, information related to another experiment corresponding to another lower object dependently connected to the first upper object on the hierarchical structure of the first area and information related to the first experiment of the first model in the comparable form. Here, another experiment is an experiment for the first model similarly to the first experiment. Here, another experiment may have the same experiment category as the first experiment. For example, when the first experiment corresponds to the compression category, another experiment may also correspond to the compression category. Display locations of information related to another experiment and information related to the first experiment on the second area may be determined based on occurrence time points of another experiment and the first experiment. For example, experiments on the second area may be sorted according to an occurrence order of the experiments. The display locations of information related to another experiment and information related to the first experiment on the second area may be determined based on performance information of another experiment and the first experiment. For example, the experiments on the second area may be sorted according to an order in which the performances of the experiments are better (e.g., an order of a higher compression rate, an order of a small latency, etc.).

In an embodiment, in a situation in which the first experiment and an experiment different from the first experiment are displayed on the second area, the user interface may receive a user selection input of selection information related to the different experiment. The user interface may display an input window for receiving an additional experiment input for a first model to which the first experiment is not applied and the different experiment is applied. As described above, information related a plurality of experiments may be displayed on the second area, and an additional experiment for the selected experiment among the plurality of experiments may be performed on the user interface. The computing device 100 may display information on an additional experiment on the second area in response to the additional experiment input, and update the hierarchical structure in the first area based on the additional experiment.

In an embodiment, when the computing device 100 receives an experiment input for performing the second experiment of the first model on the second area, the computing device 100 may display the information on the second experiment in the second area and update the hierarchical structure in the first area based on the second experiment (430).

In an embodiment, the additional experiment input may be received on the experiment pipeline corresponding to the first lower object on the second area. In this case, the experiment result corresponding to the additional experiment input may be generated, and the hierarchical structure on the first area may be updated based on the experiment result.

For example, it is assumed that the first upper object is the compression category, and the first lower object represents that the compression experiment is performed in the training model. Under the assumption, when the first lower object is selected, experiment information for representing an experiment pipeline (i.e., training-compression) corresponding to the first lower object may be displayed in the second area. A user input may be acquired, which intends to perform a compression experiment of a different scheme from a previous compression experiment on the second area on the user interface. As a result, the computing device 100 performs the different compression experiment and display the resulting experiment result in the second area. Further, the computing device 100 may display a new lower object for reflecting the experiment result according to the different compression experiment in the first area. The new lower object may be displayed in the first area in a form to be dependent on the first upper object (i.e., the compression category) in order to display a new experiment pipeline (i.e., training-different compression).

In an embodiment, when compression of a model which is trained during an experiment process of a model or a pretrained model is performed, a lower object representing the experiment pipeline for the compressed model may be automatically added to the upper object representing the experiment category corresponding to the compression.

In an embodiment, the computing device 100 may use an experiment indicator when displaying the experiment pipeline in the form of the lower object. The experiment indicator may be used as a means for indicating which experiment exists in the experiment pipeline. As a non-limited example, the experiment indicator may be indicated in a form of a text or in a form of an image (icon). The computing device 100 adds a second experiment indicator corresponding to the second experiment to a first experiment indicator corresponding to the first experiment to generate a second lower object representing an experiment pipeline including the first experiment of the first model and the second experiment of the first model. The computing device 100 may display (e.g., add or change) the generated second lower object on the hierarchical structure of the first area.

For example, when the re-training experiment is added in a situation in which the first lower object includes the training experiment, a display scheme of the second lower object may be determined by a scheme in which an experiment indicator representing the re-training experiment is connected to an experiment indicator representing the training experiment. As a result, the second lower object may be displayed in a form of being connected dependently to the upper object on the hierarchical structure. As such, the hierarchical structure may be updated in a scheme in which a new lower object is added on the first area.

For example, when the converting experiment is added in a situation in which the first lower object includes the training experiment and the compression experiment, an experiment indicator representing the converting experiment may be connected to experiment indicators representing the training experiment and the compression experiment. As the experiment indicator representing the converting experiment is connected by such a scheme, a display scheme of the first lower object may be updated to a display scheme of the second lower object. As described above, the first lower object may be updated (e.g., changed) to the second lower object in a form in which a display scheme for a specific object on the first area is changed.

In an embodiment, according to a type of performed experiment or group identification information of experiments, the update scheme of the hierarchical structure on the first area may be varied. As an example, the update scheme may include a first scheme of generating a new lower object and a second scheme of changing a display of an existing lower object. In an embodiment, when the training experiment, the re-training experiment, and/or the compression experiment are/or performed, the first scheme in which the new lower object is added on the hierarchical structure of the first area may be applied. In an embodiment, when the converting experiment and/or the benchmark experiment are/is performed, the second scheme of changing the display of the existing lower object may be applied.

In an embodiment, when updating the hierarchical structure, the computing device 100 may determine an upper object to which the second lower object corresponding to the second experiment is connected dependently based on the experiment category of the first upper object to which the first lower object is connected dependently and the type of second experiment. For example, when the first upper object corresponds to the training experiment category and the type of second experiment following the first experiment is the compression experiment, the second lower object corresponding to the second experiment may be added in a form of being the second upper object (the compression experiment category) different from the first upper object.

In an embodiment, the lower object on the hierarchical structure of the first area may display identification information of a trained model, compression information representing a compression scheme of a model, a converting indicator representing whether the model is converted, a benchmark indicator representing whether the model is benchmarked, and/or a retraining indicator representing whether the model is retrained. As an example, the identification information of the trained model and the compression information may be represented by a first type of indicator, and the converting indicator, the benchmark indicator, and the retraining indicator may be represented by a second type of indicator. As an example, the first type of indicator may include a text indicator. As an example, the second type of indicator may include an image or icon indicator.

As described above, when a new experiment pipeline is identified in response to an experiment input from a user, the computing device 100 may automatically update the hierarchical structure of the first area (for example, generate a new lower object). As a result, the user may intuitively and hierarchically identify a category and an experiment pipeline of an experiment thereof.

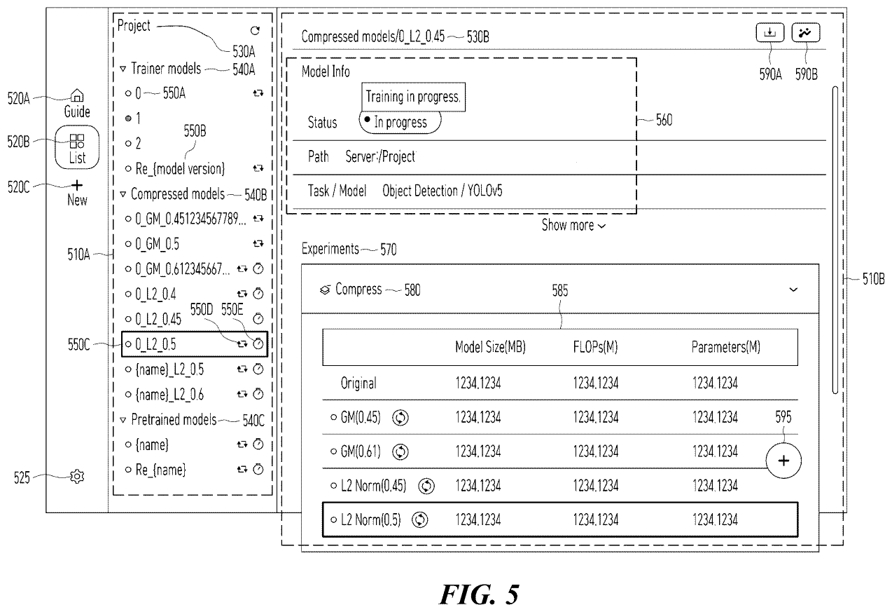

FIG. 5 exemplarily illustrates a user interface including the experiment history and the experiment result of the artificial intelligence model according to an embodiment of the present disclosure.

As illustrated in FIG. 5, the user interface may include a first area 510A representing the experiment history of the model in the form of the hierarchical structure and a second area 510B allowing the first user interaction for the experiment of the model.

In an embodiment, the user interface may display an identification indicator 530A for identifying a development project in a first area 510A. Experiments performed during the development project corresponding to the identification indicator 530A and the resulting experiment pipelines may be displayed in the hierarchical structure on the first area 510A. As illustrated in FIG. 5, an icon Refresh may be disposed at a location adjacent to the identification indicator 530A. When a selection input for the icon Refresh is acquired, the hierarchical structure of the first area 510A may be updated.

In an embodiment, the hierarchical structure for the first area 510A may be updated by a predetermined time unit. For example, the predetermined time unit may be variable such as 30 seconds, 1 minute, 2 minutes, 5 minutes, and 10 minutes. As a result, when an experiment is performed, information on the experiment and/or information for hierarchical structure update may be stored in a temporary storage space for updating the hierarchical structure, and the hierarchal structure of the first area 510A may be automatically updated by the predetermined time unit by using the information stored in the temporary storage space.

In an embodiment, the user interface may display a navigation area in an area adjacent to the first area 510A. A guide object 520A may be displayed on the navigation area, which allows an input for requesting information on a use methodology of the user interface. When a user selection input is acquired on the guide object 520A, the user selection input may be connected to a connection page related to the user interface. A list object 520B for displaying the first area 510A and the second area 510B may be displayed on the navigation area. When the list object 520B is selected in a state in which the lower object is not generated, guidance information for generating a new lower object may be displayed. When the list object 520B is selected, information on a lower object or a file which is clicked last may be displayed. A generation object 520C may be displayed on the navigation area, which allows an input for generating a new development project. When the generation object 520C is elected, a screen may be displayed, which requests an input for generating a folder for new training. When the object 520C is clicked, a pop-up window may be generated or displayed, which generates a new folder.

In an embodiment, a setting object 525 may be displayed on the user interface. When the setting object 525 is selected, information related to log-in and/or information related to an account may be displayed.

In an embodiment, the first area 510A may include upper objects 540A, 540B, and 540C representing experiment categories and lower objects 550A, 550B, and 550C connected dependently to the upper objects 540A, 540B, and 540C, respectively. For example, the upper objects 540A, 540B, and 540C may include a first upper object 540A representing a model which is trained through the user interface, a second upper object 540B representing that the model is compressed, and a third upper object 540C representing that a model is pretrained through another device. The model which is trained through the user interface may be represented as a lower object which is dependent on the first upper object 540A. The model which is pretrained through another device may be represented as a lower object which is dependent on the third upper object 540C. When the training mode is compressed, the compression model may be represented as a lower object which is dependent on the second upper object 540B.

In an embodiment, a lower object 550A is a lower object dependent on the training category. The lower object 550A may include identification information 0 of the training model. The identification information 0 of the training model may be represented as an experiment indicator of the lower object 550A. When the model is trained through the user interface, the lower object 550A may be generated on the first area 510A.

In an embodiment, the lower object 550B is a lower object dependent on the training category. The lower object 550B may include identification information (model version) of the training model and an experiment indictor Re representing the retraining experiment. The lower object 550B may represent an experiment pipeline indicating that retraining of a model which is trained with a name of (model version) is applied. The lower object 550B may be displayed in the first area 510A in a form in which the experiment indicator Re identifying the retraining experiment is added to the experiment indicator (model version) identifying the training model. When a retraining input for the training model (model version) is acquired and the training model is retrained on the second area 510B, the lower object 550B which is dependent on the first upper object 540A may be generated on the first area 510A.

In an embodiment, the lower object 550C is a lower object dependent on the compression category. The lower object 550C may include the identification information 0 of the training model and an experiment indicator L2_0.5 identifying the compression experiment. The lower object 550C may represent an experiment pipeline indicating that the compression experiment L2_0.5 is applied to the training model corresponding to the lower object 550A. The lower object 550C may be displayed in the first area 510A in a form in which the experiment indicator L2_0.5 identifying the compression experiment is added to the experiment indicator 0 identifying the training model. The experiment indicator related to compression may represent a scheme and/or a compression rate of the compression. Here, L2_0.5 represents that normalization for LAYER 2 of the training model is a compression scheme for structure pruning, and the compression rate is 0.5. Accordingly, the lower object 550C may intuitively indicate what a training model to which compression is applied and what the scheme of the compression and quantitative information of the compression is. When a compression input for the training model 0 is acquired and the training model 0 is compared on the second area 510B, the lower object 550B which is dependent on the second upper object 540B may be generated on the first area 510A.

For example, information on the training model or the training experiment corresponding to the lower object 550A may be displayed in the second area 510B in response to the user selection input to select the first lower object 550A which is dependent to the first upper object 540A on the first area 510A. When an input of intending to perform the compression experiment for the training model is received on the second area 510B, the computing device 100 may acquire the compression model corresponding to the training model. When the compression model is acquired, when the compression experiment is performed, or when the compression input is received, the computing device 100 may generate the lower object 550C and display the lower object 550C in the first area 510A in order to identify the experiment pipeline representing the compression experiment of the training model.

In an embodiment, after the compression experiment is applied, the converting experiment and the benchmark experiment for the lower object 550C (i.e., the compression model) may be applied. When the converting experiment is performed, the computing device 100 may update the hierarchical structure by a scheme of adding a converting indicator 550D to the lower object 550C. When the benchmark experiment is performed, the computing device 100 may update the hierarchical structure by a scheme of adding a benchmark indicator 550E to the lower object 550C. As illustrated in FIG. 5, the converting indicator 550D and the benchmark indicator 550E may be added to corresponding lower objects when corresponding experiments are performed, and as a result, the hierarchical structure may be updated by a scheme in which the display of the lower object is changed without newly generating the lower object. The converting indicator 550D and the benchmark indicator 550E may be displayed in the form of the icon to visually confirm respective experiments. When the lower object includes the converting indicator 550D and the benchmark indicator 550E, it may be considered that one or more converting experiments and one or more benchmark experiments are applied to the corresponding lower object.

The first area 510A in the present disclosure may display objects corresponding to a plurality of experiments in the form of the hierarchical structure (e.g., folder structure). As an example, a plurality of lower folders on the folder structure may be expressed as a lower structure of one upper folder. At least one upper object may be included in an upper folder on the folder structure, and at least one lower object may be included in a lower folder included in the upper folder. The update of the hierarchical structure may include adding a new lower object to a lower folder connected to a specific upper folder or changing name of the lower object.

In an embodiment, the second area 510B may display experiment information 570 corresponding to the lower object selected in the first area 510A. The second area 510B may display model information (e.g., original model information) 560 corresponding to the lower object selected in the first area 510A, and display a window or an object 595 which allows an input for an additional experiment.

The experiment information 570 of the second area 510B and the model information 560 illustrated in FIG. 5 may be displayed in response to selecting the lower object 550C of the first area 510A. The model information 560 may include information on the training model corresponding to the lower object 550C. The model information 560 illustrated in FIG. 5 may include training state information, storage location information, task information, and model type information related to the training model 0 corresponding to the lower object 550A. For example, the training state information may include states such as ‘Completed’, ‘In progress’, ‘Stopped’, and ‘Invalid stopped.’ A color code may be mapped to each training state. As a result, the user interface may display the training state through the color code to intuitively deliver a state related to training of a current training model (original model) to the user.

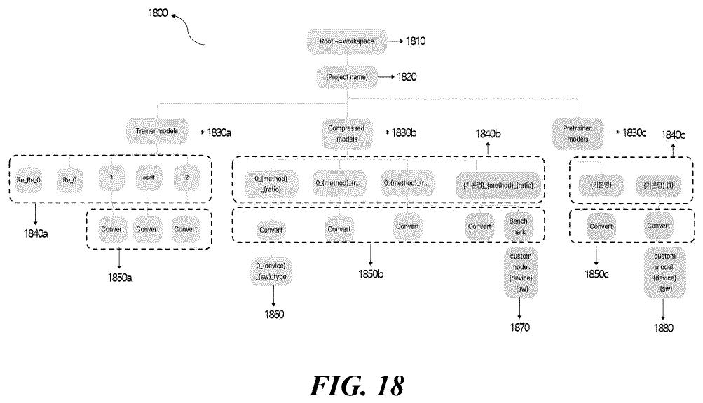

In an embodiment, Path on the model information 560 may mean a path storing information on a corresponding model and/or an experiment applied to the corresponding model. For example, Path may correspond to the folder on the folder structure storing the files in the example of FIG. 18.

When an object ‘Show more’ is selected, a window displaying an additional configuration related to training may be displayed. For example, information on a dataset of the model, information on a channel of the model, information on an input size of the model, information on an epoch of the model, information on a batch size of the model, information on a learning rate, and/or information on an optimizer may be displayed on the window displaying the additional configuration. In a situation in which the window displaying the additional configuration related to the training is displayed, an object ‘Show less’ may be displayed, and when an object ‘Show less’ is selected, the window disappears and only the model information 560 in the example of FIG. 5 may be displayed.

In an embodiment, the experiment information 570 in the second area 510B indicates detailed information on other experiments applied to the training model 0. In the example of FIG. 5, compression experiments 580 applied to the training model 0 may be displayed in the area of the experiment information 570. A compression indicator representing the compression experiments 580 in the second area 510B is the same as the compression indicator representing that the compression experiment in the first area 510A is applied.

In the example of FIG. 5, identification information of the experiments which belong to the category of the expression experiment 580 for the training model 0 and experiment result information may be displayed in a comparable format 585. The experiment result information and the identification information disclosed in reference numeral 585 are expressed for an exemplary purpose, and actual values corresponding to an actual experiment result may be different from the exemplary values.

As illustrated in FIG. 5, the information in the second area 510B may be displayed in response to the user selection input to select the lower object 550C of the first area 510A. In an embodiment, the user interface may display information on the compression experiment corresponding to the lower object 550C and other compression experiments applied to the training model 0 in the area of the experiment information 570. The lower object 550C may include a compression experiment corresponding to Norm (0.5). The experiment information 570 may display information on training model (original) and information on the compression model to which the compression experiment corresponding to the lower object 550C is applied, and information on each of other compression models to which other compression experiments are applied to the same training model in the comparable form. As illustrated in FIG. 5, the user interface may display results of a plurality of compression experiments and a result of the training experiment in the form of the table based on the same factors such as a model size, FLOP, and a parameter.

In an embodiment, when identification information corresponding to other compression experiments is selected on the area of the experiment information 570 of the second area 510B, the same result as selecting the corresponding lower object in the first area 510A may be generated. That is, experiment information of the corresponding lower object in the first area 510A may be displayed in the second area 510B.

In an embodiment, when the additional object 595 of the second area 510B is selected, an input window for allowing an additional experiment for the training model 0 may be generated. Here, the additional experiment may include an additional experiment for the training model and/or an additional experiment for the compression model L2 0.5.

In an embodiment, when the lower object 550A of the first area 510A is selected, the area of the experiment information 570 may be represented as a blank, and as a result, a window for requesting an input for allowing the user to perform the additional experiment (e.g., compression, converting, re-experiment, and/or benchmark) may be displayed.

In an embodiment, the second area 510B may include a download object 590A and a visualization object 590B.

In an embodiment, when the download object 590A is selected, download files corresponding to the training model 0, the compression model corresponding to the lower object 550C, and/or other compression models included in the area of the experiment information 570 may be generated. As a result, the compression experiment of the lower object 550C, and a series of experiments in the experiment pipeline and results of other compression experiments related to the training model may be collectively downloaded.

In an embodiment, in a situation in which the user interface displays a first experiment of the training model 0 corresponding to the lower object 550C in the second area 510B, the user interface may receive a user selection input to select the download object 590A displayed on the second area 510B. The computing device 100 may generate download files for a plurality of experiments included in the experiment pipeline corresponding to the lower object 550C. In such an embodiment download files corresponding to the training model 0 and the training model 550C and the compression model corresponding to the lower object 550C may collectively generated.

In an embodiment, when the download object 590A is selected, one download file for other compression experiments of the training model 0 may be generated in addition to the compression experiment L2 Norm_0.5 of the training model 0. As another example, a plurality of download files may also be generated in a scheme in which one download file for one experiment among the plurality of experiments is generated.

In an embodiment, when the visualization object 590B is selected, the computing device 100 may generate performance images corresponding to a plurality of experiments included in the experiment pipeline corresponding to the lower object 550C. Each of the performance images may display visually comparably display a first performance of the training model 0 to which the training experiment is applied in the experiment pipeline corresponding to the lower object 550C and a second performance of a model to which a subsequent experiment after the training experiment is applied in the experiment pipeline.

In an embodiment, when the visualization object 590B is selected, the computing device 100 may generate performance images corresponding to a plurality of experiments included in the area of the experiment information 570. The performance images may comparably display performances for respective experiments based on the same factor. The performance images may also be displayed in a form of comparing results of other experiments based on the training model 0. The performance images may display results of experiments having the same experiment category among results of a plurality of different experiments performed for the same training model to the comparable format based on the performance of the training model.

In an embodiment, the second area 510B may indicate identification information 530B for identifying the lower object 550C selected in the first area 510A.

As described above, the user interface according to an embodiment of the present disclosure may store an experiment model file in the form of the hierarchical structure (e.g., the form of the folder structure). For example, the experiment model file may be stored in the form of the folder structure corresponding to the hierarchical structure illustrated on the first area 510A. The experiment model file may be stored in a form of the experiment history and a text file including the experiment history. The experiment model file stored in the form of the text file may be expressed on the second area 510B. Since an optimization model file according to the experiment may be stored jointly with information representing the experiment history in the form of the folder structure representing the hierarchical structure, the experiment history of the model may be easily determined.

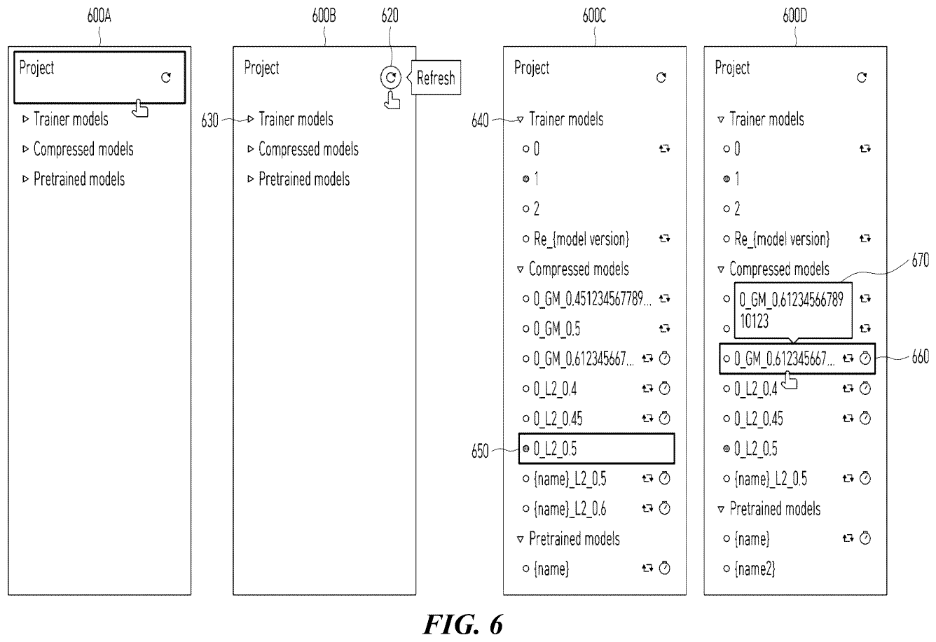

FIG. 6 exemplarily illustrates a hierarchical structure of experiment histories according to an embodiment of the present disclosure.

The description related to the contents described above among the descriptions in FIG. 6 will be omitted in order to prevent the redundancy of the description.

An additional description for the first area 510A in FIG. 5 will be illustrated in FIG. 6.

Reference numeral 600A exemplarily illustrates a first area displaying upper objects (trainer models, compressed models, and pretrained models). The upper objects may assist the user to intuitively search or identify the experiment pipeline for each experiment category. Identification information for identifying the development project may be displayed at upper portions of the upper objects. When a selection input for the identification information is received, the user interface may display a screen for setting a storage space for a corresponding development project.

When an object on reference numeral 600A is selected, a pop-up for generating a project folder may be generated or output.

Reference numeral 600B illustrates an example in which an object Refresh located adjacent to the identification information is selected. When an input cursor of the user is hovered in a state of being adjacent to the object (icon) Refresh (icon), an indicator “Refresh” illustrated in reference numeral 600B may pop-up. When the object Refresh is selected, the hierarchical structure of the first area may be updated. In reference numeral 600B, a list object 630 adjacent to (e.g., a left of) each the upper objects is displayed in a locking state which does not list the lower object.

Reference numeral 600C represents an example in which lower objects for respective upper objects are displayed. When the list object 640 adjacent to (e.g., the left of) each of the upper objects is selected, lower objects which are dependent on the selected upper object may be listed at a lower portion of the selected upper object. In this case, a shape of the list object 640 may be changed as in reference numeral 600C in order to indicate that the lower object is listed. An activation object 650 may be used for a current user to identify what is the selected lower object is and/or what a lower experiment related to experiment information currently displayed on the second area.

In reference numeral 600D, when the input cursor of the user is hovered on a specific lower object 600, a pop-up object represented by reference numeral 670 may be displayed, and a name of a last folder in a path (e.g., storage location) of the corresponding lower object may be displayed through a pop-up object 670.

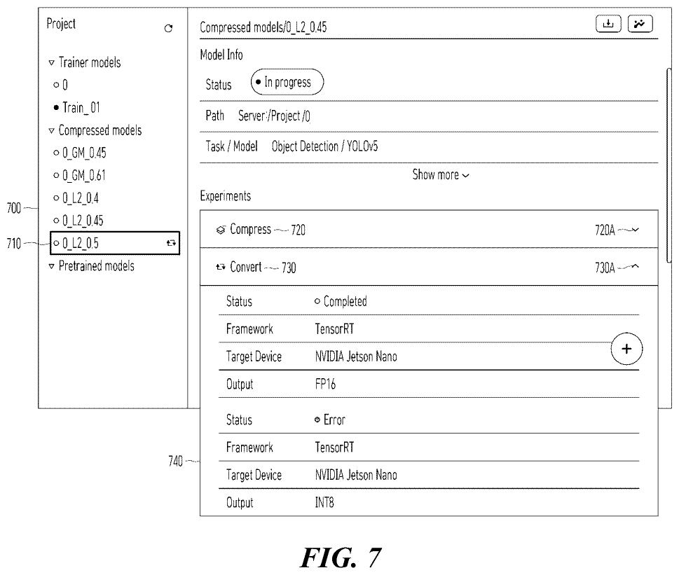

FIG. 7 exemplarily illustrates an experiment result according to an embodiment of the present disclosure.

The description related to the contents described above among the descriptions in FIG. 7 will be omitted in order to prevent the redundancy of the description.

A user interface 700 illustrated in FIG. 7 represents an exemplary screen when a lower object 710 is selected in the first area. An experiment pipeline corresponding to the lower object 710 in FIG. 7 may sequentially include the training experiment, the compression experiment, and the converting experiment. On an area experiments in FIG. 7, a compression experiment 720 and a converting experiment 730 are displayed at placement locations according to an occurrence order of additional experiments (compression and converting) of the experiment pipeline.

Details for the compression experiment 720 are listed or a list object 720A for hiding the details is displayed in a related area (e.g., a right area) of the compression experiment 720. When the list object 720A is selected, a shape of the list object 720A is changed and the details for the compression experiment 720 are displayed. The details for the compression experiment 720 are illustrated in reference numeral 585 of FIG. 5.

Details 740 for the converting experiment 730 are listed or a list object 730A for hiding the details is displayed in a related area (e.g., a right area) of the converting experiment 730. When the list object 730A is selected, a shape of the list object 730A is changed and the details 740 for the converting experiment 730 are displayed as in the example of FIG. 7. The details 740 of the converting experiment 730 may comparably display a converting-prior model and a converting-post model. The details 740 may include a current state, a framework, identification information, and an output type of each of the converting-prior model and the converting-post model.

In an embodiment, in the selected lower object 710, it may be displayed in the first area that the compression experiment L2_0.5 is applied to the training model with a name of 0, and the converting experiment is additionally applied. Here, the training experiment and the compression experiment may be displayed in the form of the text and the converting experiment may be displayed in the form of the icon. By such a scheme, identification information of the lower object on the hierarchical structure in the first area and experiment information of the lower object in the second area may be displayed to be associated with each other.

In an embodiment, when an additional object+for performing an additional experiment is selected in the second area, a specific experiment may be performed in a group constituted by retraining, compression, converting, and benchmark. For example, when the retraining is performed as the additional experiment, a new lower object to which the retraining indicator Re is added may be generated on the first area. For example, when the compression expression is performed as the additional experiment, a new lower object to which a compression indicator of the corresponding experiment is added may be generated on the first area. For example, when the benchmark experiment is performed as the additional experiment, the hierarchical structure may be updated on the first area in a form in which a benchmark indicator is added onto the lower object 710.

In an embodiment, Path in FIG. 7 may mean identification information of a directory storing information on a corresponding model and/or an experiment applied to the corresponding model. For example, Path may correspond to the folder on the folder structure storing the files in the example of FIG. 18.

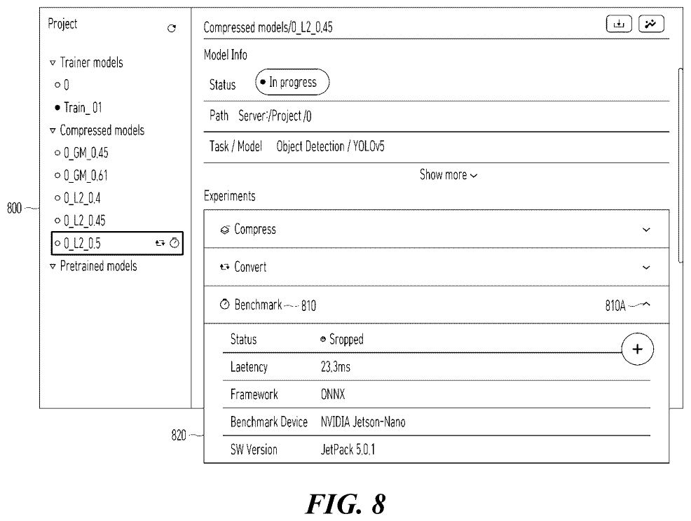

FIG. 8 exemplarily illustrates an experiment result according to an embodiment of the present disclosure.

The description related to the contents described above among the descriptions in FIG. 8 will be omitted in order to prevent the redundancy of the description.

A user interface 800 illustrated in FIG. 8 represents an exemplary screen when a lower object 0_L2_0.45 is selected in the first area. In FIG. 8, it may be confirmed that the converting indicator and the benchmark indicator are included in the lower object 0_L2_0.45 in the first area.

An experiment pipeline corresponding to the lower object 0_L2_0.45 in FIG. 8 may sequentially include the training experiment, the compression experiment, the converting experiment, and the benchmark experiment. On the area experiments in FIG. 8, the compression experiment, the converting experiment, and a benchmark experiment 810 are displayed at placement locations according to an occurrence order of additional experiments (compression, converting, and benchmark) of the experiment pipeline.

Details for the benchmark experiment 810 are listed or a list object 810A for hiding the details is displayed in a related area (e.g., a right area) of the benchmark experiment 810. When the list object 810A is selected, a shape of the list object 810A is changed and the details 820 for the benchmark experiment 810 are displayed.

The details 820 for the benchmark experiment 810 may include a state of a current model, a state of a benchmark, latency, a framework, identification information of a target device, and/or software version information.

In an additional embodiment, the details 820 for the benchmark experiment 810 may include performance information in target hardware of a target model. For example, the details 820 may include time information including preprocessing time information required for preprocessing inference of the target model at the target hardware or inference time information required for inferring the target model at the target hardware. For example, the details 820 may include memory usage information including preprocessing memory usage information used for preprocessing inference of the target model at the target hardware or inference memory usage information used for inferring the target model at the target hardware. For example, the details 820 may include memory footprint information required for executing the target model at the target hardware, latency information required for executing the target model at the target hardware, and/or power consumption information required for executing the target model at the target hardware. For example, the details 820 may include preprocessing time information required for preprocessing inference of the target model in at least one target hardware, inference time information required for inferring the target model in at least one target hardware, preprocessing memory usage information used for preprocessing the inference of the target model in at least one target hardware, inference memory usage information used for inferring the target model in at least one target hardware, quantitative information related to an inference time, which is obtained as the target model is repeatedly inferred at a predetermined number of times in at least one target hardware, and/or quantitative information related to memory use for each of the NPU, the CPU, and the GPU, which is obtained as the target model is inferred in at least one target hardware.

In an embodiment, the preprocessing time information may include time information required for preprocessing before the inference operation is performed such as calling the model. Additionally, the preprocessing time information may also include quantitative information (e.g., a minimum value, a maximum value, and/or an average value of a time required for pre-inference) related to a time required for the pre-inference when the pre-inference is repeated at a predetermined number of times for activation of the GPU, etc., before measuring a value for inference.

In an embodiment, the inference time information as time information required during an inference process may be used to encompass minimum time information, maximum time information, average time information, and/or median time information among the inference time information among time information required for an initial inference operation for the model when the mode is inferred repeatedly at the predetermined number of times, for example. Additionally, for example, in a situation in which the CPU receives and processes an operation which may not be processed by the NPU, the NPU becomes an idle state, and the inference time information may include a first cycle value when the NPU becomes the idle state. Additionally, the inference time information may also include a second cycle value when the NPU performs inference and/or a third cycle value obtained by aggregating the first cycle value and the second cycle value.

For example, the details 820 may also include total time information obtained by aggregating the preprocessing memory usage information and the quantitative information related to the inference time. For example, the details 820 may additionally include a RAM usage, a ROM usage, a total memory usage, and/or a quantitative value for an SRAM area used by the NPU.

In an embodiment, when a user input which intends to perform the benchmark experiment is received while the converting experiment is not performed on the area of the experiment information of the second area, the computing device 100 may determine whether to a guidance message indicating that the converting experiment should be performed before the benchmark experiment based on identification information and/or model information of a target device of the benchmark experiment. For example, when current model information is enabled to be driven in the target device, the computing device 100 may not generate the guidance message indicating that the converting experiment should be performed. For example, when current model information is not enabled to be driven in the target device, the computing device 100 may generate the guidance message indicating that the converting experiment should be performed.

In an embodiment, when a user input which intends to perform the benchmark experiment is received while the converting experiment is not performed on the area of the experiment information of the second area, the computing device 100 may determine whether to a guidance message indicating that the converting experiment should be performed before the benchmark experiment.

In an embodiment, according to the experiment category, a subject in which the corresponding experiment is performed may be determined. For example, the compression experiment, the converting experiment, and the benchmark experiment may be performed by another device which exists outside the computing device 100 and a result thereof may be delivered to the computing device 100. The training experiment may be performed by using an internal resource of the computing device 100.

In an embodiment, Path in FIG. 8 may mean identification information of a directory storing information (e.g., experiment input values and/or an experiment history) on a corresponding model and/or an experiment applied to the corresponding model. For example, Path may correspond to the folder on the folder structure storing the files in the example of FIG. 18.

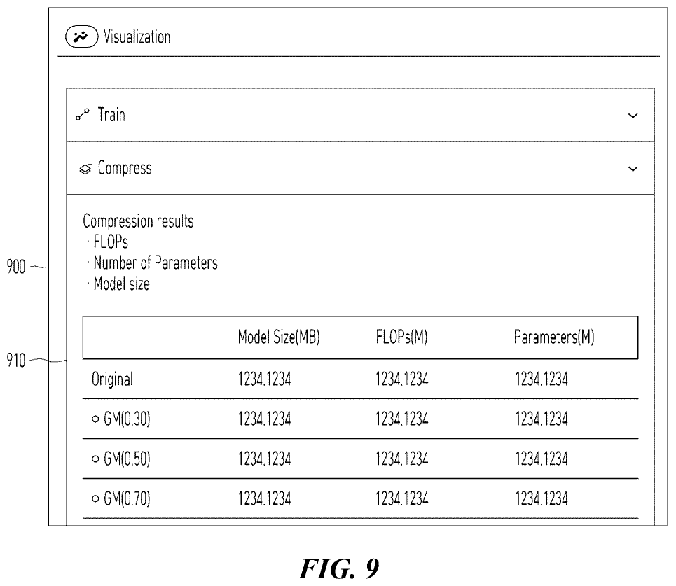

FIGS. 9, 10, and 11 exemplarily illustrate an experiment result to which a visualization element is applied according to an embodiment of the present disclosure.

Referring to FIGS. 9, 10, and 11, screens displayed when the visualization object 590B on the second area 510B in FIG. 5 is selected are exemplarily illustrated. According to an implementation aspect, the screens illustrated in FIGS. 9, 10, and 11 may be displayed as one continuous screen or displayed as separated screens, respectively.

FIG. 9 exemplarily illustrates a screen 900 for visualizing the training experiment and the compression experiment. Reference numeral 910 represents the training model (original) and a plurality of compression experiments GM_0.30, GM_0.50, and GM_0.70 applied to the training model (original) in the form of the table.

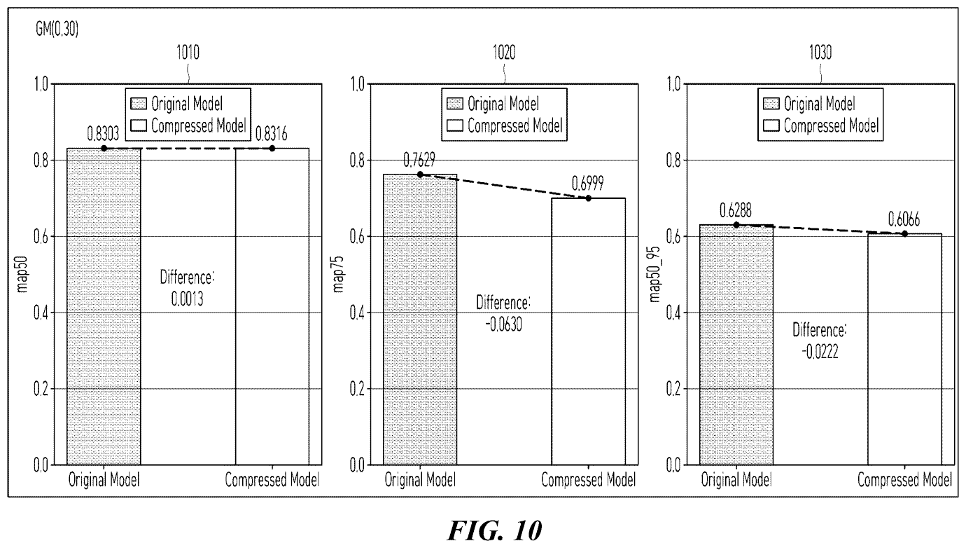

FIG. 10 exemplarily illustrates a screen 1000 for visualizing the training experiment and the compression experiment.

In FIG. 10, screens 1010, 1020, and 1030 are exemplarily illustrated, which compare performances of a training model applied to one compression experiment GM_0.30 and the original model original visually (e.g., in the form of a 2D graph).

A first screen 1010 displays a performance comparison between the training model to which the compression experiment GM_0.30 is applied and the original model Original based on a first factor map50, and displays a difference value (0.0013) between the performances jointly. Further, the first screen 1010 may display a comparison line (e.g., a dotted line) for visually comparing Y-axis values of the training model to which the compression experiment GM_0.30 is applied and the original model Original.

A second screen 1020 displays a performance comparison between the training model to which the compression experiment GM_0.30 is applied and the original model Original based on a second factor (map75), and displays a difference value (−0.0630) between the performances jointly. Further, the second screen 1020 may display the comparison line (e.g., the dotted line) for visually comparing the Y-axis values of the training model to which the compression experiment GM_0.30 is applied and the original model Original.

A third screen 1030 displays a performance comparison between the training model to which the compression experiment GM_0.30 is applied and the original model Original based on a third factor (map50_95), and displays a difference value (˜0.0222) between the performances jointly. Further, the third screen 1030 may display the comparison line (e.g., the dotted line) for visually comparing the Y-axis values of the training model to which the compression experiment GM_0.30 is applied and the original model Original.

As illustrated in FIG. 10, the screen 1000 for visualizing the compression experiment visually shows performance values under the same criterion for each of the compression model to which the compression experiment is applied and the original model, and a difference value thereof to allow a user to recognize a more intuitive experiment result and a more intuitive experiment performance.

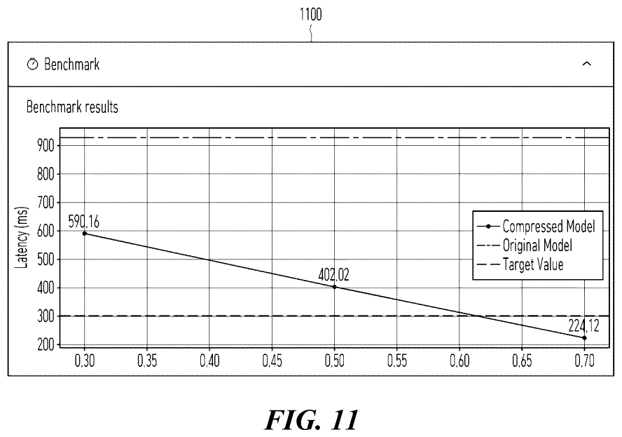

FIG. 11 exemplarily illustrates a screen 1100 for visualizing the benchmark experiment.

As illustrated in FIG. 11, the visualization screen 1100 of the benchmark experiment may compare a compressed model and an original model based on a compression rate (X axis) and a latency (Y axis). The visualization screen 1100 of the benchmark experiment may display a latency value according to a different compression rate based on the same compression scheme, for example. The visualization screen 1100 of the benchmark experiment may display a latency value according to a different compression rate based on the same model and the same hardware, for example. The visualization screen 1100 of the benchmark experiment displays a predetermined target value (target latency) jointly to allow the user to intuitively confirm which compression rate is close to a target value.

In an additional embodiment, the computing device 100 may sort a plurality of benchmark results based on the latency when the plurality of benchmark results is generated as multiple nodes are selected as multiple hardware is selected as target hardware. For example, the benchmark results may be sorted and output in an order of a smallest latency. In an additional embodiment, when there are benchmark results corresponding to a plurality of hardware in which the latency is within or is the same as a predetermined similar range, the benchmark results may be sorted additionally based on a memory usage and/or a CPU occupancy.

In an embodiment, the visualization screen 1100 of the benchmark experiment may include at least one of a first result that comparatively displays a maximum inference latency obtained by executing the target model by assuming a computing resource situation which may be slowest in the plurality of respective hardware including the target hardware, a second result that comparatively displays an average inference latency when the target model is executed at a plurality of numbers of times in a plurality of respective hardware including the target hardware, and a third result that comparatively displays an interference latency for each of the plurality of layers in the target model in the plurality of respective hardware including the target hardware. In an additional embodiment, the visualization screen 1100 of the benchmark experiment may also comparatively display a minimum inference latency obtained by executing the target model by assuming a computing resource situation which may be fastest in the plurality of respective hardware including the target hardware. In an additional embodiment, the visualization screen 1100 of the benchmark experiment may also comparatively display a latency required for an initial inference among a plurality of inferences. In an additional embodiment, the visualization screen 1100 of the benchmark experiment may also comparatively display a latency required during a warm up process of inference. In an additional embodiment, the visualization screen 1100 of the benchmark experiment may also display a median latency for the plurality of inferences to be comparable.

In an embodiment, the visualization screen 1100 of the benchmark experiment may include a fourth result that comparatively displays a processor margin value in which another operation or another application may be driven in the process of inferring the target model at the target hardware. For example, the processor margin value may include an available margin for the CPU and/or an available margin for the GPU. The benchmark result may include a fifth result that comparatively displays a memory margin value in which another operation or another application may be driven in the process of inferring the target model at the target hardware. For example, the memory margin value may include an available margin for a CPU memory and/or an available margin for a GPU memory.

In an embodiment, the visualization screen 1100 of the benchmark experiment comparably displays a performance (e.g., latency) for each of compression rates (X axis) of a compression model to which the compression experiment is applied and a performance (e.g., latency) for an original model to which the compression experiment is not applied to allow the user to intuitively confirm a result and a performance of the compression experiment. In the example of FIG. 11, a graph is exemplarily illustrated, in which as the latency of the original model exceeds 900 ms and the latency of the compression model linearly decreases as the compression rate increases. In an embodiment, the visualization screen 1100 of the benchmark experiment displays a predetermined target value or a target value (e.g., target latency) selected by the user jointly with the performances to assist the user to select a compression rate suitable for the target value.

In an embodiment, the screen 1100 in FIG. 11 may be output for each selected hardware. Results of the benchmark experiments for the plurality of hardware may be comparably output. The target value of FIG. 11 may be variably determined according to the type of hardware.

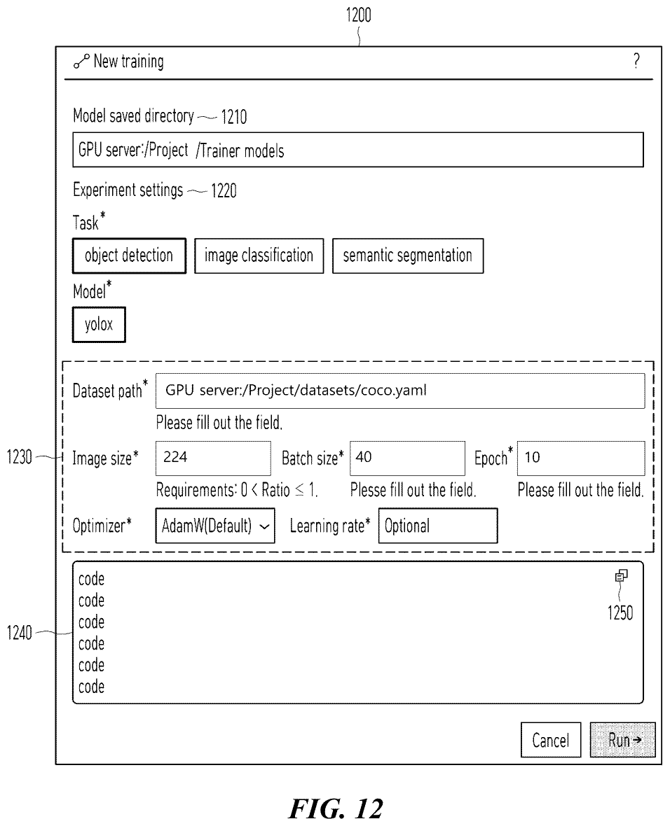

FIG. 12 exemplarily illustrates a user interface 1200 of a training experiment according to an embodiment of the present disclosure.

As a non-limited example, the user interface 1200 may be displayed on the second area of FIG. 5. As another example, the user interface 1200 may be displayed on an entire area including the first area and the second area of FIG. 5. As another example, the user interface 1200 may be displayed in the form of a new window other than the first area and the second area of FIG. 5.

In an embodiment, the user interface 1200 illustrates an exemplary screen which requests an experiment input for training a model and receives the experiment input in order to start the experiment pipeline.

The user interface 1200 may provide an input window 1210 for designating a storage path of the training model. A predetermined recommended storage path may also be displayed to match the hierarchical structure for the experiment history on the input window 1210.

The user interface 1200 may provide an input object 1220 which allows an experiment setting input for setting the training experiment. The input object 1220 may include task input objects (object detection, image classification, and semantic segmentation) for identifying a task of the training model and model type objects (e.g., yolox) for determining the type of model. As a result, the user may define a model to be trained and a task, and efficiently determine a setting value appropriate thereto by using a GUI.

The user interface 1200 may provide a training setting input window 1230 for receiving a storage location of a training dataset to be used for training the model and receiving a configuration related to the training. For example, the user interface 1200 may receive information such as an image size, a batch size, an epoch, an optimizer, and/or a learning rate through the window 1230. At least some of the inputs may also be automatically determined and displayed on the user interface 1200 based on the training dataset. When Task is selected in a part Task/model in the user interface 1200, a lower model may be displayed and a training value may be set. Here, the training dataset may be represented as a blank so as to be directly input by the user. As described above, the training setting may be automatically determined according to the setting of the task.

In an embodiment, when the user interface 1200 receives an input related to experiment setting and training setting of the training model, and when a user input to select a code generation object 1250 is received, codes which may be used as inputs may be automatically generated by different user interfaces. The generated codes are compatible with different user interfaces which so as to be used as a training input in the user interface. The computing device 100 may output information related to training input through the GUI in the form of the code. The output code is usable as an input in another user interface which is operable by using the code as the input. On the contrary, when a code used on another user interface which supports the development project of the model is input into a code input window 1240 through the code type input, an experiment (e.g., training) of the model based on the corresponding code may be executed.

In an embodiment, the user interface 1200 may display a code input window 1240 for receiving a code input for performing the training experiment apart from the input object 1220 for setting the training experiment and the window 1230 for receiving a configuration to the training experiment. As a result, the user may input training related configuration information having a high freedom degree and having a desired from in the form of the code. In such an embodiment, reference numeral 1250 may be used as a copy object 1250 for copying an input code. A copied code may be used as an input on another user interface which is operable through the code input.

In an embodiment, an object Run on the user interface 1200 is selected, the training of the model may be executed according to the information input through the GUI or input in the form of the code.

In an embodiment, a model saved directory 1210 in FIG. 12 may mean identification information of a directory storing information (e.g., experiment input values and/or an experiment history) on a corresponding model and/or an experiment applied to the corresponding model. For example, the model saved directory 1210 may correspond to the folder on the folder structure storing the files in the example of FIG. 18.

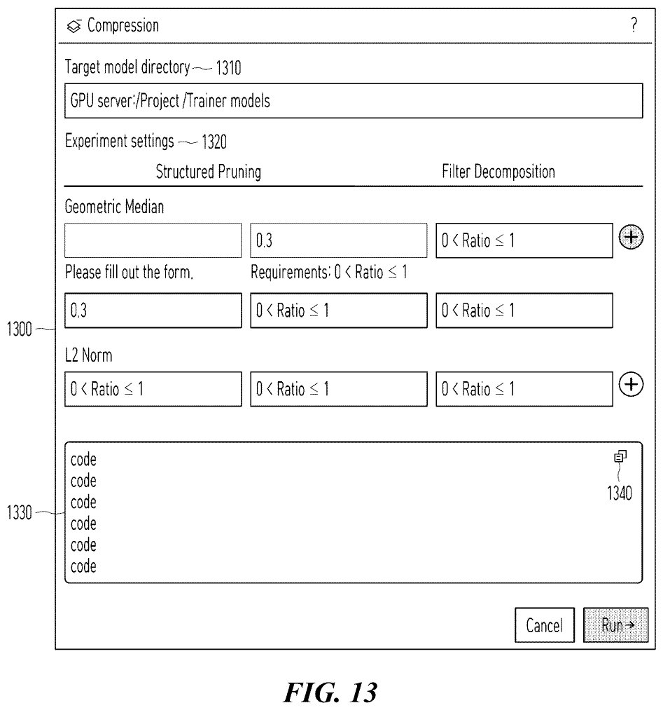

FIG. 13 exemplarily illustrates a user interface 1300 of a compression experiment according to an embodiment of the present disclosure.

As a non-limited example, the user interface 1300 may be displayed on the second area of FIG. 5. As another example, the user interface 1300 may be displayed on an entire area including the first area and the second area of FIG. 5. As another example, the user interface 1200 may be displayed in the form of a new window other than the first area and the second area of FIG. 5.

In an embodiment, the user interface 1300 illustrates an exemplary screen which requests an experiment input for compressing the training model on the Al fl pipeline, and receives the experiment input.

The user interface 1300 may provide an input window 1310 for designating a storage path of the compression model. A predetermined recommended storage path may also be displayed to match the hierarchical structure for the experiment history on the input window 1310. For example, the recommended storage path may be displayed so that the storage location of the file of the training model and the file of the compression model may be associated with each other. For example, the hierarchical structure of the first area may be configured to match the folder structure storing the file, and as a result, the user interface 1300 may provide an indication of newly generating a folder to which the hierarchical structure is reflected, and recommending the generated folder.

The user interface 1300 may provide an input object 1320 which allows an experiment setting input for setting the compression experiment. The input window 1320 may receive information related to the compression scheme and the compression rate. The computing device 100 may also automatically determine a compression scheme and a compression rate suitable for the training model stored on the input window 1320, and display the determined compression scheme and compression rate in the input window 1320 in advance.

The user interface 1300 may change information and placement of an input window to be displayed based on the compression scheme selected by the user. The user interface 1300 may provide different input windows for different compression schemes (structure pruning and filter decomposition).

In an embodiment, when the user interface 1300 receives an input related to experiment setting and training setting of the compression model, and when a user input to select a code generation object 1340 is received, codes which may be used as inputs may be automatically generated by different user interfaces. The generated codes are compatible with different user interfaces which so as to be used as a compression input in the user interface. The computing device 100 may output information related to training input through the GUI in the form of the code. The output code is usable as an input in another user interface which is operable by using the code as the input. On the contrary, when a code used on another user interface which supports the development project of the model is input into a code input window 1330 through the code type input, an experiment (e.g., compression) of the model based on the corresponding code may be executed.

In an embodiment, the user interface 1300 may display a code input window 1330 for receiving the code input for performing the compression experiment apart from the input window 1320 for setting the compression experiment. As a result, the user may input compression related configuration information having a high freedom degree and having a desired from in the form of the code. In such an embodiment, reference numeral 1340 may be used as a copy object 1340 for copying an input code. A copied code may be used as an input on another user interface which is operable through the code input.

In an embodiment, codes for performing the experiment, which correspond to user inputs on the user interface 1300 may be automatically generated, and the codes generated automatically as described above may be displayed on the code input window 1330 of the user interface 1300.

In an embodiment, an object Ron on the user interface 1300 is selected, the compression of the model may be executed according to the information input through the GUI or input in the form of the code.

In an embodiment, the user interface 1300 may allow a plurality of compression experiments to be executed by one input (selecting the object Run).

In an embodiment, a target model directory 1310 in FIG. 13 may mean identification information of a directory storing information (e.g., experiment input values and/or an experiment history) on a corresponding model and/or an experiment applied to the corresponding model. For example, the target model directory 1310 may correspond to the folder on the folder structure storing the files in the example of FIG. 18.

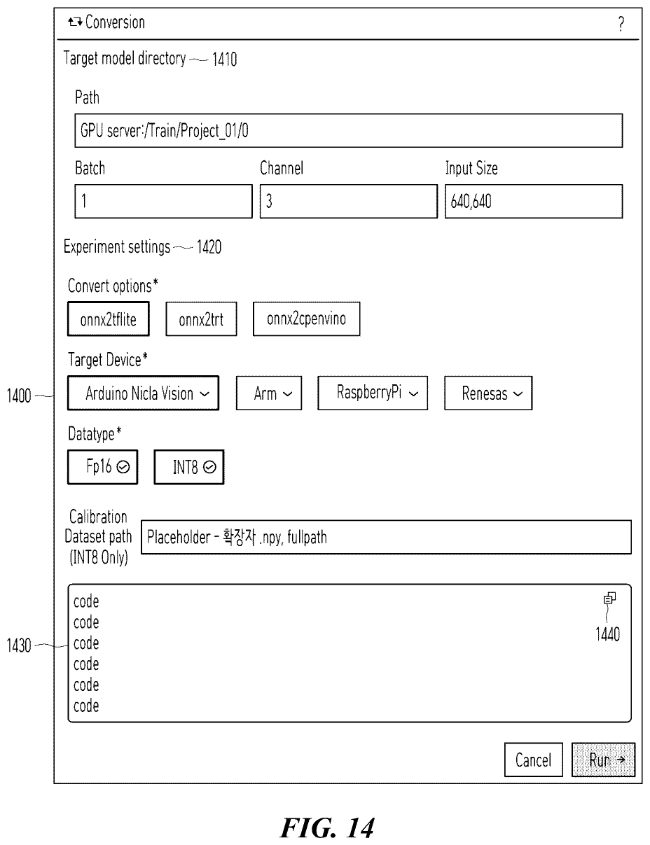

FIG. 14 exemplarily illustrates a user interface 1400 of a converting experiment (or conversion experiment) according to an embodiment of the present disclosure.

As a non-limited example, the user interface 1400 may be displayed on the second area of FIG. 5. As another example, the user interface 1400 may be displayed on an entire area including the first area and the second area of FIG. 5.

In an embodiment, the user interface 1400 illustrates an exemplary screen which requests an experiment input for converting the training model on the pipeline, and receives the experiment input.

The user interface 1400 may provide an input window 1410 for designating a storage path of a target model of converting and/or a storage path for the converted model. The input window 1410 may receive a batch, a channel, and an input size of the target model of the converting and the converted model.

The user interface 1400 may display the predetermined recommended storage path on the input window 1310 to match the hierarchical structure for the experiment history. For example, the recommended storage path may be displayed so that the storage location of the file of the training model or the compression model and the storage location of the file of the converted model may be associated with each other. For example, the hierarchical structure of the first area may be configured to match the folder structure storing the file, and as a result, the user interface 1400 may provide an indication of newly generating a folder to which the hierarchical structure is reflected, and recommending the generated folder.

The user interface 1400 may provide an input object 1420 which allows an experiment setting input for setting the converting experiment. The input objects 1420 may receive information related to Converting options of selecting the framework of the converted model, Target device of selecting the target hardware of the converting model, and Datatype of determining a data type of the converting model. The user interface 1400 may additionally display a window for receiving a path of Calibration Dataset.

In an embodiment, the user interface 1400 may operate to perform a plurality of converting experiments at once in response to a user input to select a plurality of data types.

In an embodiment, when the user interface 1400 receives an input related to converting setting of the model, and when a user input to select a code generation object 1440 is received, codes which may be used as inputs may be automatically generated by different user interfaces. The generated codes are compatible with different user interfaces which so as to be used as a converting input in the different user interface. The computing device 100 may output information related to training input through the GUI in the form of the code. The output code is usable as an input in another user interface which is operable by using the code as the input. On the contrary, when a code used on another user interface which supports the development project of the model is input into a code input window 1430 through the code type input, an experiment (e.g., converting) of the model based on the corresponding code may be executed.

In an embodiment, the user interface 1400 may display a code input window 1430 for receiving the code input for performing the converting experiment apart from the input objects 1420 for setting the converting experiment. As a result, the user may input converting related setting information having a high freedom degree and having a desired from in the form of the code. In such an embodiment, reference numeral 1440 may be used as a copy object 1440 for copying an input code. A copied code may be used as an input on another user interface which is operable through the code input.

In an embodiment, codes for performing the experiment, which correspond to user inputs on the user interface 1400 may be automatically generated, and the codes generated automatically as described above may be displayed on the code input window 1430 of the user interface 1400.

In an embodiment, the object Run on the user interface 1400 is selected, the converting of the model may be executed according to the information input through the GUI or input in the form of the code.

The user may convert a specific model with a model framework desired by the user through the user interface 1400 which allows the GUI or code type input.

In an embodiment, Path of a target model directory 1410 in FIG. 14 may mean identification information of a directory storing information (e.g., experiment input values and/or an experiment history) on a corresponding model and/or an experiment applied to the corresponding model. For example, Path of the target model directory 1410 may correspond to the folder on the folder structure storing the files in the example of FIG. 18.

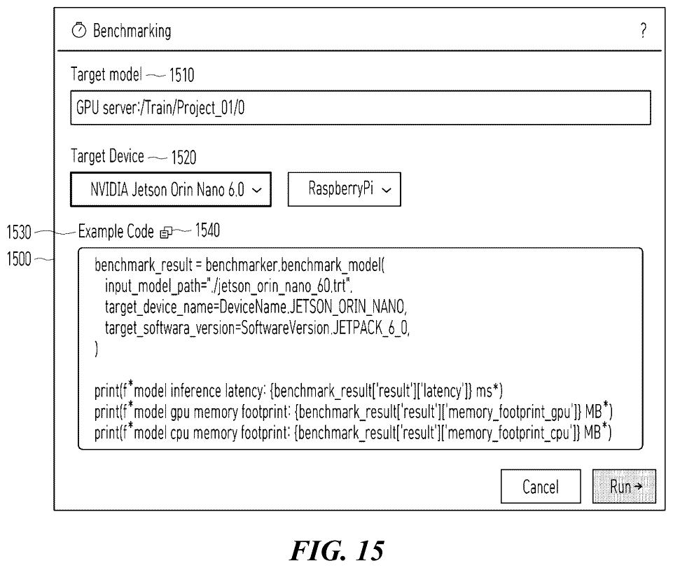

FIG. 15 exemplarily illustrates a user interface 1500 of a benchmark experiment according to an embodiment of the present disclosure.

As a non-limited example, the user interface 1500 may be displayed on the second area of FIG. 5. As another example, the user interface 1500 may be displayed on an entire area including the first area and the second area of FIG. 5. As another example, the user interface 1200 may be displayed in the form of a new window other than the first area and the second area of FIG. 5.

In an embodiment, the user interface 1500 illustrates an exemplary screen which requests an experiment input for benchmarking a model and receives the experiment input in order to start the experiment pipeline.

The user interface 1500 may provide an input window 1510 for designating a model which becomes a target of benchmark and a benchmark result. A predetermined recommended storage path may also be displayed to match the hierarchical structure for the experiment history on the input window 1510. In an embodiment, the input window 1510 may mean identification information of a directory storing information (e.g., experiment input values and/or an experiment history) on a corresponding model and/or an experiment applied to the corresponding model. For example, the input window 1510 may correspond to the folder on the folder structure storing the files in the example of FIG. 18.

The user interface 1500 may provide input objects 1520 which allow an input of the target device (target hardware) for the benchmark experiment. The input objects 1520 may be used for identifying the target device, and may be activated or deactivated during the user selection input. The active object and the deactivated object may be distinguishably displayed with a color.

In an embodiment, when the user interface 1500 receives an input related to the benchmark of the model, and when a user input to select a code generation object 1540 is received, codes which may be used as inputs may be automatically generated by different user interfaces. The generated codes are compatible with different user interfaces which so as to be used as a benchmark input in the user interface. The computing device 100 may output information related to training input through the GUI in the form of the code. The output code is usable as an input in another user interface which is operable by using the code as the input. On the contrary, when a code used on another user interface which supports the development project of the model is input into a code input window 1540 through the code type input, an experiment (e.g., benchmark) of the model based on the corresponding code may be executed.

In an embodiment, reference numeral 1530 represents that input information for the benchmark experiment input through the GUI is expressed as an exemplary code.

In an embodiment, the user interface 1500 may display a code input window 1530 for receiving the code input for performing the benchmark experiment apart from the input window 1520 of the benchmark experiment and the code input window 1510 of the benchmark experiment. As a result, the user may input training related configuration information having a high freedom degree and having a desired from in the form of the code. In such an embodiment, reference numeral 1540 may be used as a copy object 1540 for copying an input code. A copied code may be used as an input on another user interface which is operable through the code input.

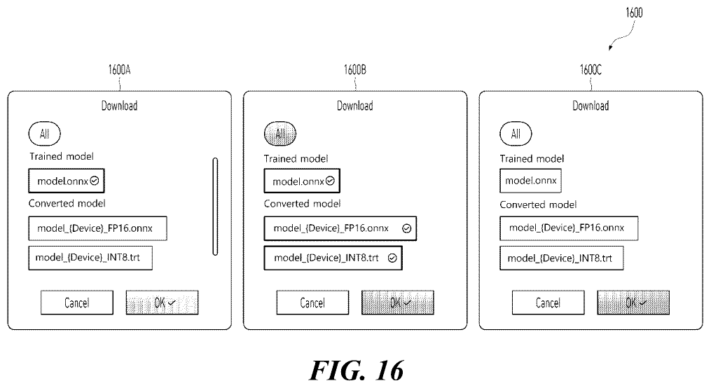

FIG. 16 exemplarily illustrates a user interface 16000 (1600A, 1600B, and 1600C) for downloading an experiment result according to an embodiment of the present disclosure.

The user interface 1600 (1600A, 1600B, and 1600C) of FIG. 16 illustrates screens displayed when the download object 590A is selected

In an embodiment, the computing device 100 may generate download files corresponding to a plurality of experiments included in the experiment pipeline corresponding to the elected lower object. File names of download files may be automatically configured to correspond to identifiers of the lower objects expressed on the hierarchical structure of the first area. It may be possible to collectively download the plurality of experiments through the GUI. The download files may be generated in a scheme in which one download file for one experiment among the plurality of experiments is generated.

In an embodiment when the experiment pipeline which becomes a download target includes the converting experiment, a first download file corresponding to a model before the converting experiment is applied and a second download file corresponding to a model to which the converting experiment is applied may be generated. Here, a name of the first download file may include a first type of quantization unit and a name of the second download file may include a second type of quantization unit. For example, in the case of the first download file, the file name may include an FP16 unit and in the case of the second download file, the file name may include an INT8.

In an embodiment, the user interface 1600 displays a download setting screen 1600A displayed when a download object is selected. The download setting screen 1600A may display the identification information for the training model. The download setting screen 1600A may display identification information for the converted model separately before and after converting. The download setting screen 1600A may display information for downloading a plurality of converting models to different files according to the converting scheme. When the plurality of converting experiments are performed, collective download for the converting experiments may be allowed.

In an embodiment, the user interface 1600 displays a download setting screen 1600B displayed when a use input All of selecting the collective download is received. When the user input All is received, it may be indicated that the training model (converting-prior model) and the converting-post model are collectively selected. When the user input All is received, it may be indicated that an input to select separate download files for the data types of the converting-post model, respectively is made.

In an embodiment, the user interface 1600 displays a download setting screen 1600C showing a form in which an activated object is deactivated in response to a user selection input for the activated object. For example, when a selection input for the ‘All’ object is received from the user, all activated objects may be displayed to be deactivated. For example, when a selection input for a specific object is received from the user, the selected specific object may be changed from an activated state to a deactivated state. The user interface 1600 may visually distinguishably display the selected activated object and the unselected deactivated object. As an example, the user interface 1600 may highlight the activated object (selected object) (for example, representing a contour line of an object in a bold form, changing a color of the contour line, changing an internal color of the object, etc.).

In an embodiment, the computing device 100 may acquire a name of a folder storing a downloadable file. For example, the folder name may be predetermined according to the type of experiment as Trainer models, Compressed models, pretrained models, and converted models. In an embodiment, the computing device 100 may request the user to input names of download files or automatically generate download file names in the form of the lower objects included in the hierarchical structure of the first area.

In an embodiment, download files included in the experiment pipeline of the lower object selected by the user or download files corresponding to other lower objects to which experiments related to the lower object are applied may be collectively downloaded. The name of the download file may also be automatically determined according to a name of the experiment pipeline. The name of the download file may be automatically determined to correspond to names of objects on the hierarchical structure.

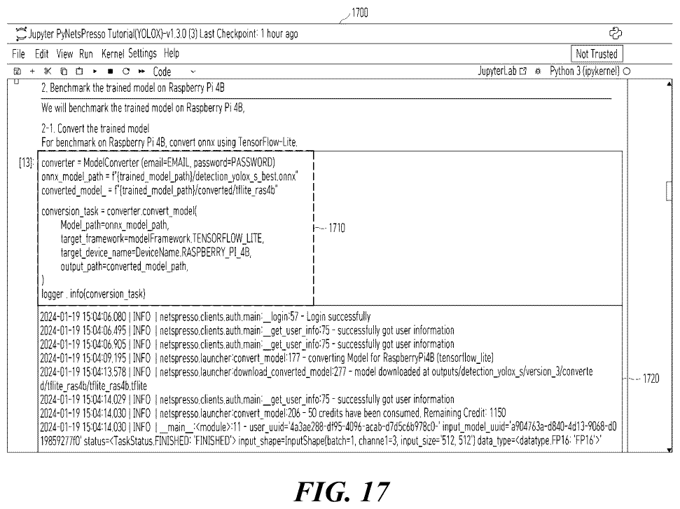

FIG. 17 exemplarily illustrates a second user interface 1700 of the present disclosure.

In an embodiment, it is exemplarily illustrated that the second user interface 1700 illustrated in FIG. 17 converts onnx by using TensorFlow-Lite and acquires a user input for benchmarking the corresponding model in Raspberry Pi 4B hardware.

In an embodiment, the second user interface 1700 is enabled to interlock with the user interface described above for the same development project. That is, results of experiments performed through the second user interface 1700 may be used to update the hierarchical structure of the first area on the user interface described above.

In an embodiment, the computing device 100 may display an input area 1710 for allowing a second user interaction for experimenting a model on the second user interface 1700 for the development project. Here, the second user interaction may generate the experiment result of the model similarly to the GUI input on the user interface described above, and update the hierarchical structure according to the experiment result of the model.

In an embodiment, when receiving a user code input for a customized experiment of the model on the input area 1700, the computing device 100 may update the hierarchical structure of the user interface in the first area based on the customized experiment corresponding to the user code input. As an example, the user code input may include a Python based code input.

In an embodiment, the second user interface 1700 may display a processing area 1720 displaying a processing process of an experiment corresponding to an input of the customized experiment. As a result, an error during an experiment process may be easily identified.

In an embodiment, the second user interface 1700 may perform the experiment for the model by using the code input generated by the user interface. In an embodiment, the code input used in the second user interface may be used as a code input on the experiment area on the user interface.

In an embodiment, the second user interface 1700 may operate as a separate application from the user interface described above. For example, the user may directly create a code (e.g., python code) for the experiment of the model through a second application (e.g., Jupiter notebook) providing the second user interface, and as a result, training, compression, converting, and/or benchmark of the model may be performed. For example, the user may arbitrarily adjust an experiment and an execution order through the second user interface, so it may be possible to optimize models of various scenarios. As an experiment having a high freedom degree of the user is allowed, there may be a need for more efficiently managing results for respective experiments. As a result, the computing device 100 according to an embodiment of the present disclosure generates and updates an object of an experiment pipeline unit representing histories of experiments through the user interface described above to more efficiently manage the results of the experiment and the history of the experiment.

In an embodiment, a second experiment result acquired through the second user interface 1700 allowing the code type input and a first experiment result acquired through the user interface allowing the GUI type input may interlock with each other. This may mean that the hierarchical structure constituted by a plurality of layers on the first area on the first user interface may be updated based on the second experiment result acquired through the second user interface 1700. Further, this may mean a second experiment subsequent to the first experiment result of the first user interface may be performed through the code input on the second user interface 1700. Further, this may mean that the experiment input code to be utilized in the second user interface 1700 may be automatically generated in response to a selection input of selected objects in the user interface allowing the GUI type input.

In an embodiment, the computing device 100 may interlock the second experiment result of the second user interface 1700 with the first experiment result of the user interface by a scheme of comparing second path information in the user input code in the second user interface 1700 allowing the input of the code and first path information on the user interface allowing the input of the GUI.

A technique according to an embodiment of the present disclosure displays a lower object corresponding to an experiment pipeline starting from the training model (or pretrained model) is displayed in the hierarchical structure of the first area on the user interface to achieve a technical effect of being capable of efficiently managing the experiment history for the development project.

In the technique according to an embodiment of the present disclosure, when the experiment on the second area is performed, the hierarchical structure of the first area is updated (for example, added or changed) based on the performed experiment to achieve a technical effect of being capable of efficiently managing the experiment history for the development project.

In the technique according to an embodiment of the present disclosure, an upper layer on the hierarchical structure may be distinguished based on the experiment category and a lower layer may be displayed to be distinguished based on the experiment pipeline. As a result, a technical effect that the category of the experiment for the model and the experiment pipeline may be intuitively confirmed may be achieved.

The technique according to an embodiment of the present disclosure allows an intuitive experiment configuration for the model through the GUI and allows a customized experiment configuration for the model through the code input to achieve a technical effect of being capable of executing various types of experiments for the model according to needs and/or a level of the user.

In the technique according to an embodiment of the present disclosure, as mutual interlocking between user interfaces allowing different types of inputs is implemented, a technical effect that various types of experiments for the model may be executed according to the needs and/or the level of the user, and user convenience may be maximized in model development may be achieved.

FIG. 18 illustrates an exemplary folder structure 1800 according to an embodiment of the present disclosure.

The folder structure 1800 illustrated in FIG. 18 exemplarily represents a directory structure storing information (e.g., input information for the experiment, history information for the experiment, result information of the experiment, and/or model information which becomes a target of the experiment) related to the experiment according to an embodiment of the present disclosure. For example, the folder structure 1800 may correspond to the hierarchical structure of the present disclosure. For example, the folder structure 1800 may correspond to the hierarchical structure of the present disclosure. For example, the hierarchical structure of the present disclosure may be reflected to the folder structure 1800.

In an embodiment, in order to allow the experiment history of the model to be easily determined, when the experiment is performed, a file related to the experiment may be stored in the form of the hierarchical structure. A text file (e.g., a Jason file) including experiment input information, experiment history information, and/or experiment result information may be stored in a specific folder on the folder structure 1800 illustrated in FIG. 18. The information included in the text file may be expressed in the second area on the user interface.

In an embodiment, when an experiment on the user interface is performed, meta information (e.g., the experiment input information and/or the experiment history information) related to the corresponding experiment may be stored in a specific folder on the folder structure 1800 illustrated in FIG. 18 even in the form of the text file. Further, when the experiment on the user interface is performed, result information (e.g., an optimization model file) related to the corresponding experiment may be stored in a specific folder on the folder structure 1800 illustrated in FIG. 18. For example, when the experiment is performed, the text file representing the meta information and the experiment model file representing the experiment result information may be stored in the specific folder.

In an embodiment, since the optimization model file according to the experiment is stored in the specific folder in the folder structure 1800 jointly with the experiment history according to a designated rule, it may be possible to efficiently manage the experiment history of the model.

In an embodiment, information selected or inserted as an input may be stored in the form of the text file during an experiment process of the model. Input values during the experiment process may be loaded on the second area and output on the second area.

In an embodiment, the folder structure 1800 illustrated in FIG. 18 represents the folder structure in the storage space of the computing device 100. When an experiment is performed in the development project, a result of the corresponding experiment may be stored in a specific folder on a folder structure of a storage unit in the computing device 100. As a non-limited example, the corresponding folder structure 1800 may also be included in an external storage (e.g., a cloud storage) accessible by the computing device 100.

As illustrated in FIG. 18, the folder structure 1800 may be divided into a plurality of layers.

For example, a folder of a highest layer represents a workspace 1810 for starting a related experiment pipeline. As a related experiment is performed, the corresponding workspace is set as a highest folder to generate or display a lower folder which has a plurality of layers in the highest folder.

For example, a lower folder 1820 having, as an input, a name of a project (set by the user or automatically set) may be generated as the lower folder of the highest folder.

For example, as lower folders of the folder 1820 for representing the project name, a trainer models folder 1830a for a file related to training of a model, a compressed models folder 1830b for storing a file related to compression of the model, and a pretrained models folder 1831c for storing a file related to a pretrained model may be structuralized. The trainer models folder 1830a, the compressed models folder 1830b, and the pretrained models 183 1c may correspond to upper objects which belong to an upper layer in the hierarchical structure of the first area on the user interface. As described above, the folder structure storing the file related to the experiment may be interlocked or associated with the hierarchical structure of the first area on the user interface. Folders corresponding to reference numerals 1810, 1820, 1830a, 1830b, and 1830c may be generated simultaneously as a project for performing experiments is started.

In an embodiment, when an experiment related to the training of the model is performed, a folder 1840a may be generated, which corresponds to the experiment in the trainer models folder 1830a. A name (or a file name) of the generated folder 1840a may have a name for identifying the experiment pipeline for training the model. For example, a folder name Re_0 may represent that retraining is performed once in an experiment result for training a model 0. For example, a folder name Re_Re_0 may represent that retraining is performed twice in the experiment result for training the model 0. The name of the folder storing the result of the experiment related to the model training may correspond to the identification information expressed on the hierarchical structure of the first area of the user interface.

In an embodiment, when converting is performed after the training of the model, a Convert folder 1850a may be generated as a lower folder of the folder 1840a related to the training. As a result, result information of the converting experiment after the training of the model may be stored in the Convert folder 1850a. Files stored in the Convert lower folder 1850a may represent an experiment result of the experiment pipeline in which the converting experiment is made after the training experiment. As the files stored in the folder structure are read by the computing device 100, meta information regarding the corresponding files may be displayed in the second area on the user interface. Additionally, a lower folder having a folder name for identifying the converting experiment may be generated as the lower folder of the Convert folder 1850a.

In an embodiment, when the benchmark experiment is performed after the training experiment, a Benchmark folder may be generated as the lower folder of the folder 1840a related to the training.

In an embodiment, when an experiment related to the compression of the model is performed, a folder 1840b related to the experiment may be generated in the Compressed models folder 1830b. A name of the generated folder 1840b may have a name for identifying the experiment pipeline for the compression of the model. For example, when the folder name (or file name) includes 0, this may indicate that a training model according to a training experiment of a model having identification information of 0 is used for compression. The file name for the compression experiment may represent a compression method and/or a compression ratio a d &o/19 as the folder name. When the experiment related to the model compression is performed, the name of the generated folder may be generated by using information for identifying a model (e.g., the training model), information for identifying the compression scheme, and/or information for the compression ratio. A name of a folder storing a result of the experiment related to the model compression may correspond to the identification information expressed on the hierarchical structure of the first area of the user interface.

In an embodiment, when converting or benchmark is performed after the compression of the model, a lower folder 1850b of the folder 1840b related to the compression may be generated. As a result, result information of the converting or benchmark experiment after the compression of the model may be stored in the lower folder 1850b. As the files stored in the folder structure are read by the computing device 100, meta information regarding the corresponding files may be displayed in the second area on the user interface.

In an embodiment, when the converting experiment is performed, a lower folder 1860 having a file name for identifying the converting experiment may be generated as the lower folder of the Convert folder of reference numeral 1850b. A name of the lower folder 1860 may be determined by using information (0) for identifying the training model, information (device) regarding a device in which the model is to be executed, software (sw), and/or a type (type).

In an embodiment, when the benchmark experiment is performed, a lower folder 1870 having a file name for identifying the benchmark experiment may be generated as the lower folder of the Benchmark folder of reference numeral 1850b. A name of the lower folder 1870 may be determined by using information (custom model) for identifying a model which becomes the target of the benchmark, information (device) regarding a device which becomes the target of the benchmark, and information for identifying the software (sw) of the model.

In an embodiment, when an experiment is performed by using the pretrained model or when the pretrained model is acquired, a folder 1840c corresponding to the experiment or the pretrained model may be generated in the Pretrained models folder 1830c. A name (or a file name) of the generated folder 1840c may have a name for identifying the pretrained model. When the pretrained model is acquired or when an experiment related to the pretrained model is performed, a name of a folder storing the corresponding model file or a result of the corresponding experiment is stored may correspond to the identification information expressed on the hierarchical structure of the first area of the user interface.

In an embodiment, when converting for the pretrained model is performed, a Convert folder 1850c may be generated as a lower folder of the folder 1840c related to the pretrained model. As a result, result information of the converting experiment after the pretrained model may be stored in the Convert folder 1850c. Files stored in the Convert lower folder 1850c may represent an experiment result of the experiment pipeline in which the converting experiment for the pretrained model is made. As the files stored in the folder structure are read by the computing device 100, meta information regarding the corresponding files may be displayed in the second area on the user interface. Additionally, a lower folder having a folder name for identifying the converting experiment may be generated as the lower folder of the Convert folder 1850c. Additionally, when the benchmark experiment is performed, a folder 1880 for identifying the benchmark experiment may be generated.

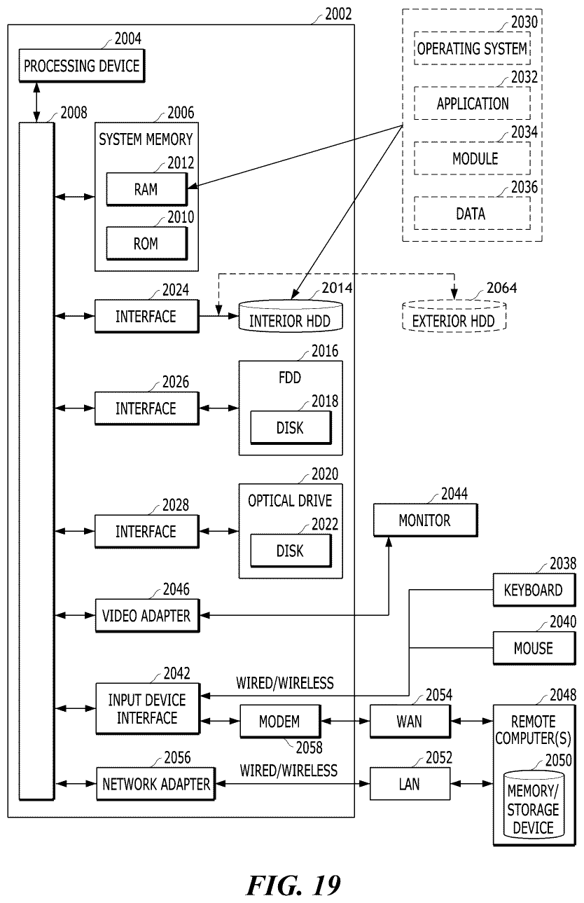

FIG. 19 is a schematic view of a computing environment of the computing device 100 according to an embodiment of the present disclosure.

In the present disclosure, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (e.g., EIDE, SATA), an external hard disk (e.g., USB, Thunderbolt, eSATA) 2014, a magnetic floppy disk drive (FDD) 2016 (e.g., for reading from or writing to a removable diskette 2018), solid-state drives (SSD), and an optical disk drive 2020 (e.g., for reading from a CD-ROM disc 2022 or from other high-capacity optical media such as DVDs, or writing to them). The hard disk drives 2014 and 2064, magnetic disk drive 2016, and optical disk drive 2020 can each be connected to the system bus 2008 through their respective interfaces: a hard disk drive interface 2024, a magnetic disk drive interface 2026, and an optical drive interface 2028. The interface 2024 for implementing external drives may include, for example, at least one of or both USB (Universal Serial Bus) and IEEE 1394 interface technologies.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a computing device, comprising:
presenting a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display selected experiment categories and a lower layer with at least one lower object that identifies an experiment pipeline of the model within each of the experiment categories, each of the experiment categories corresponds to one upper object, and the lower object is connected dependently to the upper object;
in response to receiving an object selection input to select a first lower object connected dependently to a first upper object in the hierarchical structure of the first area, displaying a first experiment of a first model corresponding to the first lower object in the second area; and
in response to receiving an experiment input to perform a second experiment of the first model in the second area, displaying information related to the second experiment in the second area and updating the hierarchical structure in the first area based on the second experiment.

2. The method of claim 1, wherein the experiment categories comprise: a first experiment category indicating that training of the model has been performed, a second experiment category indicating that compression of the model has been performed, and a third experiment category indicating that the model is a pretrained model, and
when compression is performed on a trained model or a pretrained model during an experiment process of the model, a lower object representing an experiment pipeline for the compressed model is added under an upper object representing the second experiment category.

3. The method of claim 1, wherein the experiment pipeline identifies experiments applied to the model from among a group of experiments including training, retraining, compression, converting, and benchmarking.

4. The method of claim 1, wherein the updating the hierarchical structure comprises:
displaying, on the hierarchical structure, a second lower object representing an experiment pipeline that includes the first experiment and the second experiment of the first model, by adding a second experiment indicator corresponding to the second experiment to a first experiment indicator corresponding to the first experiment of the first model.

5. The method of claim 1, wherein the updating the hierarchical structure comprises:
determining an upper object to which a second lower object corresponding to the second experiment is connected dependently, based on an experiment category of the first upper object to which the first lower object is dependently connected and a type of the second experiment.

6. The method of claim 1, wherein a lower object on the hierarchical structure in the first area displays identification information of a trained model, compression information indicating a compression method of the model, a converting indicator indicating whether a model is converted, a benchmark indicator indicating whether a model is benchmarked, and a retraining indicator indicating whether a model is retrained.

7. The method of claim 1, wherein the second area displays results of experiments with the same experiment category among multiple different experiments performed on the same trained model in a comparable format based on the performance of the trained model.

8. The method of claim 1, wherein the displaying the first experiment of the first model corresponding to the first lower object in the second area comprises:
displaying, in the second area, storage location of a file corresponding to the first model, identification information of the first model, task information of the first model, type of the first experiment, a target device of the first experiment, and current experiment status of the first experiment.

9. The method of claim 1, wherein the displaying the first experiment of the first model corresponding to the first lower object in the second area comprises:
displaying, in the second area, information related to a third experiment corresponding to a third lower object connected dependently to the first upper object in the hierarchical structure in the first area, in a comparable format with information related to the first experiment;
wherein the third experiment is an experiment on the first model and is performed before the second experiment, and display positions of information related to the third experiment and information related to the first experiment in the second area are determined based on occurrence times of the third experiment and the first experiment.

10. The method of claim 9, further comprising:
after the displaying, in the second area, information related to the third experiment in a comparable format with and information related to the first experiment, displaying an input window to receive an additional experiment input corresponding to a fourth experiment on the first model to which the first experiment is not applied and the third experiment is applied, in response to a user selection input selecting information related to the third experiment in the second area; and
in response to the additional experiment input, displaying information related to the fourth experiment in the second area and updating the hierarchical structure in the first area based on the fourth experiment.

11. The method of claim 9, wherein the displaying, in the second area, information related to the third experiment in a comparable format with and information related to the first experiment comprises:
displaying, in the second area, information related to a fifth experiment corresponding to a fifth lower object connected dependently to a second upper object different from the first upper object in the hierarchical structure of the first area, together with information related to the third experiment and information related to the first experiment, in a comparable format; and
wherein the method further comprise: providing an access to the fifth lower object and displaying, in the second area, storage location of a file corresponding to the first model, identification information of the first model, task information of the first model, and current experiment status of the fifth experiment, in response to a user selection input selecting information related to the fifth experiment in the second area;
wherein the fifth experiment is an experiment for training the first model and is performed before the first experiment and the third experiment, and the first experiment and the third experiment are experiments for compressing the trained first model.

12. The method of claim 1, further comprising:
after the displaying the first experiment of the first model corresponding to the first lower object in the second area, receiving a user selection input selecting a download object displayed in the second area; and
generating download files corresponding to multiple experiments included in a first experiment pipeline corresponding to the first lower object;
wherein the first experiment pipeline corresponding to the first lower object includes the first experiment of the first model and another experiment of the first model performed before the first experiment, and the download files are generated such that one download file is created for each experiment among the multiple experiments.

13. The method of claim 12, wherein the generating the download files corresponding to the multiple experiments included in the first experiment pipeline corresponding to the first lower object comprises:
generating a first download file corresponding to the first model before application of the converting experiment and a second download file corresponding to the first model after the application of the converting experiment, when the converting experiment is included in the first experiment pipeline; and
wherein a name of the first download file includes a quantization unit of a first type, and a name of the second download file includes a quantization unit of a second type.

14. The method of claim 1, further comprising:
after the displaying the first experiment of the first model corresponding to the first lower object in the second area, receiving a user selection input selecting a visualization object displayed in the second area; and
generating performance images corresponding to multiple experiments included in the first experiment pipeline corresponding to the first lower object; and
wherein each of the performance images visually displays, in a comparable format, a first performance of the first model in which a training experiment is applied within the first experiment pipeline and a second performance of the first model to which a subsequent experiment is applied after the training experiment within the first experiment pipeline.

15. The method of claim 1, further comprising:
displaying an input area in a second user interface for the development project to allow for a second user interaction for an experiment of the model; and
in response to receiving user code input for a customized experiment of the first model in the input area, updating the hierarchical structure in the first area of the first user interface based on the customized experiment of the first model corresponding to the user code input; and
wherein the second user interface and the first user interface are different user interfaces that allow different types of input and are interworked for the development project.

16. The method of claim 15, wherein the second area of the first user interface displays code information generated to perform the first experiment of the first model in response to a user code generation input, and wherein the code information is compatible with the user code input for the customized experiment in the second user interface.

17. The method of claim 1, wherein, when the experiment of the model includes training or retraining of the model, the training or retraining of the model is performed using computing resources of the computing device, and
wherein when the experiment of the model includes compression, converting, or benchmarking of the model, an experiment request related to the experiment of the model is transmitted to a second computing device external to the computing device, the compression, converting, or benchmarking of the model is performed using computing resources of the second computing device, and an experiment result corresponding to the experiment request of the model is transmitted from the second computing device to the computing device.

18. A computer program included in a non-transitory computer-readable medium, wherein when the computer program is executed by a computing device, the computer program allows the computing device to perform a method, and the method comprises:
presenting a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display selected experiment categories and a lower layer with at least one lower object that identifies an experiment pipeline of the model within each of the experiment categories, each of the experiment categories corresponds to one upper object, and the lower object is connected dependently to the upper object;
in response to receiving an object selection input to select a first lower object connected dependently to a first upper object in the hierarchical structure of the first area, displaying a first experiment of a first model corresponding to the first lower object in the second area; and
in response to receiving an experiment input to perform a second experiment of the first model in the second area, displaying information related to the second experiment in the second area and updating the hierarchical structure in the first area based on the second experiment.

19. A computing device comprising:
at least one processor;
a memory; and
a display;
wherein the at least one processor is configured to:
present a user interface for a development project of an artificial intelligence model, wherein the user interface comprises a first area that represents an experiment history of the model in the form of a hierarchical structure and a second area that allows for a first user interaction for an experiment of the model, the hierarchical structure comprises an upper layer with upper objects that distinguishably display selected experiment categories and a lower layer with at least one lower object that identifies an experiment pipeline of the model within each of the experiment categories, each of the experiment categories corresponds to one upper object, and the lower object is connected dependently to the upper object;
in response to receiving an object selection input to select a first lower object connected dependently to a first upper object in the hierarchical structure of the first area, display a first experiment of a first model corresponding to the first lower object in the second area; and
in response to receiving an experiment input to perform a second experiment of the first model in the second area, display information related to the second experiment in the second area and update the hierarchical structure in the first area based on the second experiment.
